(19) United States
(12) Patent Application Publication
(10) Pub. No.: US 2026/0359094 A1
(43) Pub. Date: Nov. 12, 2026

(54) SUPPORT FOR MULTI-SITE ACTIVE STANDBY HIGH AVAILABILITY FOR KUBERNETES APPLICATIONS

(71) Applicant: Nutanix, Inc., San Jose, CA (US)

(72) Inventors: Prakash Narayanasamy, San Jose, CA (US); Nikhil Loya, Bangalore (IN); Navneet Viswanath Arakony, San Jose, CA (US)

(73) Assignee: Nutanix, Inc., San Jose, CA (US)

(21) Appl. No.: 19/733,599

(22) Filed: Jul. 7, 2026

Related U.S. Application Data
(63) Continuation-in-part of application No. 19/079,361, filed on Mar. 13, 2025.
Application No. 19/079,361 is a continuation-in-part of application No. 18/819,997, filed on Aug. 29, 2024.
(60) Provisional application No. 63/566,128, filed on Mar. 15, 2024.
(60) Provisional application No. 63/566,114, filed on Mar. 15, 2024.
(60) Provisional application No. 63/840,260, filed on Jul. 8, 2025.

(51) Int. Cl. G06F 9/455; G06F 16/27

(52) U.S. Cl. CPC G06F 9/45558; G06F 16/275; G06F 2009/45579; G06F 2009/45591; G06F 2009/45595

(57) ABSTRACT

A system for configuring a data management application within a Kubernetes cluster residing at a secondary site. A processor executes the sequence of instructions to cause the processor to perform acts comprising, configuring a storage infrastructure at the secondary site to be accessible by the secondary site Kubernetes cluster, wherein the storage infrastructure is configured to implement synchronous replication of/O originating from a Kubernetes cluster residing at a primary site; configuring the secondary site Kubernetes cluster, wherein the secondary site Kubernetes cluster is configured to host a newly configured instance of a primary site data management application on the secondary site and; invoking a Kubernetes cluster deployment module configured to synthesize one or more operations to achieve a declarative no-code configuration of a desired state of one or more data management functions of the primary site data management application.

### RELATED APPLICATIONS

The present application claims the benefit of priority to U.S. Provisional Patent Application Ser. No. 63/840,260 titled “ACTIVE STANDBY HIGH AVAILABILITY APPLICATIONS IN KUBERNETES,” filed on Jul. 8, 2025, and the present application is a continuation-in-part of and claims the benefit of priority to U.S. patent application Ser. No. 19/079,361 titled “OBSERVING AND GOVERNING ONGOING USE OF INFRASTRUCTURE RESOURCES WHEN RUNNING SELF-SERVICE KUBERNETES WORKLOADS,” filed on Mar. 13, 2025, which claims the benefit of priority to, U.S. patent application Ser. No. 18/819,997 titled “ZERO-CODE ADMINISTRATION OF DATA MANAGEMENT FOR CONTAINERIZED WORKLOADS,” filed on Aug. 29, 2024, which claims the benefit of priority to U.S. Provisional Patent Application Ser. No. 63/566,128 titled “ZERO-CODE ADMINISTRATION OF CONTAINERIZED DATA MANAGEMENT WORKLOADS,” filed on Mar. 15, 2024, and U.S. Provisional Patent Application Ser. No. 63/566,114 titled “OBSERVING AND GOVERNING USE OF INFRASTRUCTURE RESOURCES WHEN RUNNING SELF-SERVICE KUBERNETES WORKLOADS” filed on Mar. 15, 2024, all of which are hereby incorporated by reference in their entirety.

### TECHNICAL FIELD

This disclosure relates to high availability computing, and more particularly to techniques for deployment of declarative, no-code, high availability data management applications in an active standby mode Kubernetes applications.

### BACKGROUND

Conventional techniques for deploying high availability data management applications within virtualization systems exhibit many deficiencies. Even modern open-source container orchestration platforms designed to automate the deployment, scaling, and management of containerized applications across diverse environments suffer from deficiencies that inhibit an application that has not been built ground up for active/standby configuration to be easily enhanced to provide high availability and resilience to site failures. What is needed is a technique or techniques that address such deficiencies.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems and methods for active high availability data management applications in Kubernetes, which techniques advance the relevant technologies to address technological issues with legacy approaches. More specifically, the present disclosure describes techniques that form and/or are used in implementing and continually maintaining an active standby data management application in Kubernetes. Certain embodiments are directed to technological solutions for orchestrating interactions of containerized data management application so as to facilitate establishment and maintenance of an active regime between two or more Kubernetes clusters.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1A and FIG. 1B illustrate technological improvements that lead to an active high availability data management application that runs on a geographically distal Kubernetes virtualization system, according to an embodiment.

FIG. 1C and FIG. 1D illustrate various technological improvements that apply to an active high availability data management application that runs on a geographically distal Kubernetes virtualization system, according to an embodiment.

FIG. 2A is a flowchart depicting a declarative no-code technique for deploying an active high availability data management application, according to an embodiment.

FIG. 2B is a flowchart depicting setup operations for deploying an active high availability data management application, according to an embodiment.

FIG. 2C is a flowchart depicting ongoing operations for maintaining states of an active high availability data management application, according to an embodiment.

FIG. 2D presents one example of a state chart depicting the transitioning of Kubernetes workloads between Kubernetes clusters during a cutover operation, according to an embodiment.

FIG. 3 illustrates a user interface for configuring high-availability parameters and synchronization policies of a data management application in Kubernetes, according to an embodiment.

FIG. 4A depicts a flowchart that describes operations and decisions that a user interface handler might process, according to an embodiment.

FIG. 4B depicts a flowchart for mapping a declarative configuration request into infrastructure-level operations so as to achieve a desired state of a computing cluster, according to an embodiment.

FIG. 5 presents an example of an agent-directed data management application deployment, according to an embodiment.

FIG. 6 is presented to illustrate a user interface as used in configuring a drill, according to an embodiment.

FIG. 7A exemplifies an event-driven failover scenario in which active virtual entities of an alternate site become the primary virtual entities, according to an embodiment.

FIG. 7B exemplifies an event-driven failback scenario in which virtual entities of the alternate site are migrated to newly reconfigured infrastructure, according to an embodiment.

FIG. 8 depicts system components as arrangements of computing modules that are interconnected so as to implement certain of the herein-disclosed embodiments.

FIG. 9A, FIG. 9B, FIG. 9C, and FIG. 9D depict virtualization system architectures comprising collections of interconnected components suitable for implementing embodiments of the present disclosure and/or for use in the herein-described environments.

### DETAILED DESCRIPTION

Aspects of the present disclosure solve problems associated with Kubernetes which, by itself, fails to offer sufficient built-in facilities to aid in high-availability deployments. Some embodiments are directed to approaches for orchestrating interactions of containerized data management application so as to facilitate establishment and maintenance of an active regime between two or more Kubernetes clusters. The accompanying figures and discussions herein present example environments, systems, and methods for implementing and maintaining an active standby data management application in Kubernetes.

### Overview

Kubernetes has become ubiquitous. Computing applications are regularly deployed into containerized environments such as Kubernetes. Unfortunately, Kubernetes was not designed with stateful applications in mind. However, business requirements (e.g., high availability, rapid disaster recovery, etc.) are common in stateful applications commonly found in enterprise settings (e.g., database applications and data protection applications).

In some cases, such stateful applications need to deliver an extremely high degree of up-time (e.g., so called five nines or 99.999% up-time guarantees). Kubernetes, by itself, fails to offer sufficient built-in facilities to aid in high availability (HA) deployments. More particularly, Kubernetes by itself fails to offer sufficient built-in facilities to aid in deployments and ongoing maintenance of self-service, active data management application scenarios. To further explain, one glaring Kubernetes deficiency that this disclosure addresses it to advance over the need of Kubenetes to require three sites (e.g., three failure domains) for providing high availability for applications. The advances in this disclosure provide solutions that only require two sites (e.g., two failure domains), which solutions cater to certain enterprise customers (e.g., “on-prem” customers) and certain other customers which do not wish to incur the costs of the (potentially very significant amounts of) infrastructure for three fully fleshed out sites. When availing of the disclosed advances, only two fully fleshed out sites are required. In some cases, the aforementioned two fully fleshed out sites can be augmented with a thin (light-weight) witness facility hosted on an arbitrary third site so as to support automatic failover.

Those of skill in the art are able to appreciate that Kubernetes was designed originally for stateless ephemeral and horizontally scalable workloads such as web services or microservices. On the other hand, and in stark contrast, data management applications such as are discussed herein, are extraordinarily stateful and have extraordinarily high performance requirements for various types of consistency (e.g., application-level consistency). Kubernetes as of today simply cannot by itself serve as a high availability data management facility. On the other hand, the aspect that Kubernetes was indeed designed for horizontally scalable workloads, and the aspect that Kubernetes systems, by virtue of its underlying architecture, are inherently reliable, it comes to bear that Kubernetes-based data management applications could possibly play an important role in a high availability situation—so long as the herein-disclosed techniques are made available to administrators and/or users of the eventual HA system.

This now brings attention to various technologies that underly the technological reach of a self-service user who, using declarative, no-code specifications can deploy or cause to be deployed a high availability data management application that, in spite of the aforementioned deficiencies of Kubernetes, is able to run in an HA mode (e.g., an active standby mode) in Kubernetes.

The impact of the foregoing cannot be overstated. In recent times, it has emerged that ongoing administration of applications running in a Kubernetes containerized system involve at least two separate but inextricably intertwined computer management functions: (1) ongoing management of infrastructure (e.g., mostly pertaining to hardware resources), and (2) ongoing management of applications that run on said infrastructure. Typically, ongoing management of infrastructure is handled by a first type of human resource (often referred to herein as an “IT person”), whereas ongoing management of applications is handled by a second type of human resource (often referred-to herein as a “DevOps person”).

Over time, it can happen that either or both the infrastructure needs and/or the application needs change. More particularly, it can happen that infrastructure demands, usually handled by an “IT person,” and/or data management application demands, usually handled by a “DevOps person,” result in the need to make changes to the infrastructure or to the data management application, or both. Accordingly, some mechanism needs to be provided such that changes to infrastructure, such as changes that are brought about by an IT person, and/or can be dealt-with by a DevOps person. In the reverse, some mechanism needs to be provided such that changes to application demands (e.g., as specified by a DevOps person) is supported by corresponding changes to infrastructure (if needed) and implemented (if needed) by an IT person.

Strictly as one example, consider that a DevOps person might want to ensure that data management operations pertaining to an application are sufficiently robust so as to survive an outage (e.g., even a catastrophic outage) without perceptible loss of functionality. In such a case, the DevOps person might define (or refer to) some sort of policy such as a policy that requires and/or institutes an active standby mode for the data management application. Those of ordinary skill in the art will recognize that this policy would impact the infrastructure at least to the extent that a second backup or standby site would need to be configured, and would further recognize that at least twice as much storage (in aggregate) would be needed to accomplish the desired HA reliability.

Those of ordinary skill in the art will immediately recognize that the Kubernetes foundational storage model is a very simple model, involving attaching a volume, mounting the volume to a pod, using the volume by the pod, then detaching and possibly moving the volume. This very simple storage model works for basic storage scenarios, but is insufficient for dealing with synchronous replication, nor is the simple Kubernetes storage model apt to handle multi-writer distributed file systems, nor are quorum based storage clusters, etc. This is because Kubernetes does not have any native synchronous replication primitive, nor does it support any transactional or atomic multi-volume operation semantics. As a result the limitations as heretofore described force vendors to implement further operational layers, and/or custom controllers, and so on.

Fortunately, virtualization system vendors have implemented the aforementioned custom controllers. This then raises the specter that virtualization system vendors can take advantage of the combination of ease of use of Kubernetes executable containers, Kubernetes statelessness, and Kubernetes horizontally scalable workload capabilities together with virtualized entities that do support the needed storage model. What is disclosed herein are architectural models that seize advantage of both (1) virtualized entities in a well-developed virtualization system together with (2) the built in and highly desirable container-based capabilities of Kubernetes.

There remains the question of why, in the face of the foregoing deficiencies of Kubernetes with respect to storage models, why the virtualization system vendor would use Kubernetes at all for data management operations. The answer, at least for purposes of this disclosure, is that Kubernetes lends itself particularly well to self-service administration. That is to say, data management has moved from the province of an IT department to the province of DevOps personnel. It can be said that the DevOps personnel need not be particularly skillful at the code level. In fact many DevOps people do not write code at all. Instead they operate at the level of commands and/or they operate at the level of defining a desired state of their system using a declarative no-code model to come up with system specifications.

To make this more concrete, consider a DevOps person who is charged with ensuring that (for example) no more than 1 second of in-flight orders might be lost in the event of some sort of catastrophic failure. Such a DevOps person might not be able to know how to code that requirement and/or might not know how much bandwidth is required to accomplish that objective and/or the DevOps person might not be able to specify storage tiering as might be required to accomplish that objective. However, the DevOps person would almost certainly be able to specify some requirements at a higher level such as, “Take a snapshot of in-flight data at 1 minute intervals and make sure there is a second copy of such snapshots that are stored in a second site.” A self-service capability, sometimes called a self-service kiosk or a “no code” kiosk, is needed to be able to translate high level requirements such as mentioned in the foregoing scenario into configurations that are applied to either or both of (1) software infrastructure and/or (2) hardware infrastructure.

In addressing the need for self-service administration of data management activities arising from containerized workloads, a Kubernetes cluster deployment module is configured to synthesize operations that are intended to achieve a desired state of data management functions that are pertinent to preparing for and executing in a failover (and failback) scenario.

To address this need, various DevOps specifications (e.g., specifications of a recovery time objective, specifications for a crash-consistent snapshot facility, or specifications for a recovery point optimization facility, etc.) for a failover or disaster recovery configuration are permitted to be provided by a self-service user (e.g., a DevOps person) using declarative, no-code specifications. Based on the declarative, no-code specifications, a cluster creation module implements operations to configure an alternate Kubernetes cluster that is capable of serving in accordance with an active redundancy regime in spite of the aforementioned limitations of the overly simple Kubernetes storage model. In some situations, a cluster creation module determines a need to actually create an alternate Kubernetes cluster, which creation activity can be performed on any available resources at any site (e.g., at a failover site).

In an example deployment, a secondary Kubernetes cluster is network connected to a primary Kubernetes cluster and is configured to match a primary site's application and services installation so as to comport with the active redundancy regime. The aforementioned network is configured with sufficient resources to be able to (1) initially bring-up the alternate Kubernetes cluster to match the state of the data management functions of the primary Kubernetes cluster, and to (2) maintain the desired state of the data management functions under changing conditions. Furthermore, and as applicable under said changing conditions, storage infrastructure constructs on which the alternate Kubernetes cluster is implemented is continually instructed to maintain the desired state of the data management functions. The storage infrastructure of the primary and alternate sites can be implemented as an HCI cluster or can be implemented as some other storage infrastructure.

Now, returning to the discussion of ongoing management of a Kubernetes cluster, in some cases, ongoing management is aided by an “IT person” and/or in some cases, ongoing management is aided by a “DevOps person, and in yet further cases, and so as to facilitate high-performance ongoing management of a Kubernetes cluster, the concept of computer-aided ongoing management module is comprehended by this disclosure. Any known technique can be used to facilitate ongoing management, however, with respect to generalized computer-aided ongoing management, specific techniques for observing and governing ongoing use of infrastructure resources when running workloads in Kubernetes clusters are employed in certain of the embodiments.

Strictly as examples, various techniques pertaining ongoing management of a Kubernetes cluster are described in U.S. patent application Ser. No. 19/079,361 titled “OBSERVING AND GOVERNING ONGOING USE OF INFRASTRUCTURE RESOURCES WHEN RUNNING SELF-SERVICE KUBERNETES WORKLOADS,” filed on Aug. 29, 2024.

The figures below and their corresponding written descriptions teach how to initially implement (and then maintain) a Kubernetes cluster so as to initially (and then on an ongoing basis) match the state of the data management functions as well as to maintain coherency to the desired state of the data management functions, even under changing conditions. In case of a loss of functionality of the primary Kubernetes cluster, an alternate Kubernetes cluster can take over in a manner that is imperceptible to users. Furthermore, since the primary Kubernetes cluster and the secondary Kubernetes cluster are cooperating in the aforementioned active regime such that there is no loss of committed data even in the event of a failover.

### DEFINITIONS AND USE OF FIGURES

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

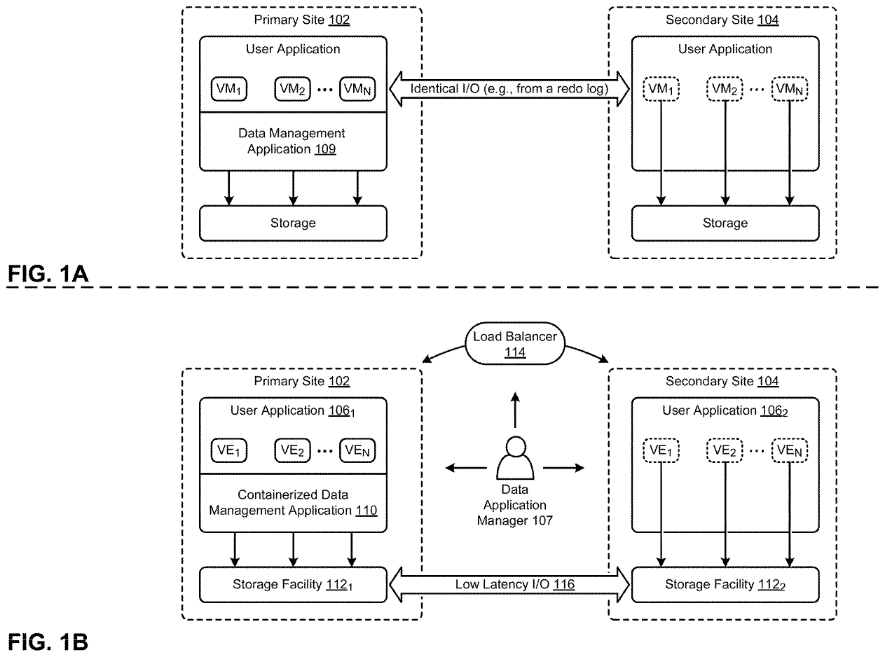

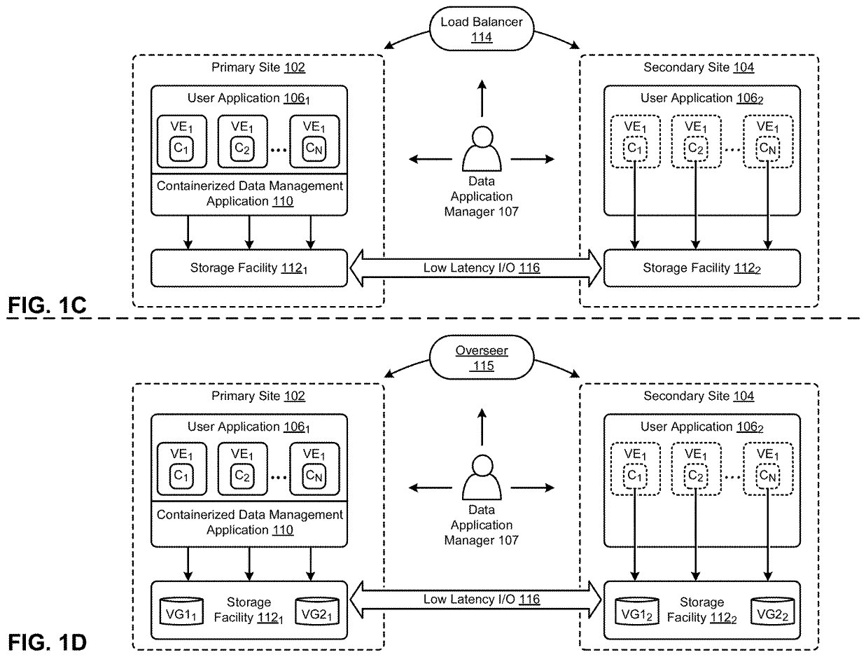

FIG. 1A and FIG. 1B are presented together to provide context for understanding how the disclosed systems improve upon less-optimal approaches to high-availability data management applications that run on a geographically distal Kubernetes virtualization systems. FIG. 1A illustrates a representative legacy configuration in which a virtualization infrastructure provides virtual machine-level replication using a replay method (e.g., replay from a log file or journal). While this architecture offers the possibility that no data is lost in a disaster recovery scenario, the recovery time is far too long. Furthermore, the executing entities are virtual machines (e.g., virtual machineVM₁, virtual machineVM₂, . . . , virtual machineVM_{N}) that implement a user application, which, in spite of having the services of a hypervisor available, and in spite of having a pan-cluster data management application 109, and in spite of having the (potentially) geographically distal sites (e.g., primary site 102 and secondary site 104) that ostensibly provide the possibility for data recovery, the virtual machines may not have easy access to scalability features that are built in to Kubernetes, and/or it might turn out that the deployed Kubernetes system fails to support needed capabilities.

FIG. 1B, by contrast, is an architecture based on executable containers that run within the context of Kubernetes. The embodiment shown replaces virtual machines for virtualized entities (e.g., VE₁, VE₂, . . . , VE_{N}) of any ilk, which virtualized entities can be any one or more of, or combinations of, virtual machines, and/or virtualized executable containers, and/or other virtualized components such as virtual storage devices, and/or virtualized network interfaces, etc. Further, FIG. 1B introduces an enhanced arrangement that incorporates a containerized data management application 110, a load balancing facility (e.g., load balancer 114), and a low latency I/O 116 which, whether deployed singly or in combination, facilitates cross-site synchronization of storage (e.g., storage facility 1121, storage facility 112₂) so as to enable continuous protection (e.g., via synchronous data replication) against disasters.

FIG. 1B illustrates merely one example of a system architecture that demonstrates a technological progression towards an active high-availability data management configuration implemented across geographically distinct sites. In particular, FIG. 1B illustrates an example of an improved active configuration in which a containerized data management application 110, possibly under instructions from a DevOps person (e.g., data application manager 107) is able to coordinate synchronization and workload distribution between geographically separated sites. Specifically in this embodiment, the containerized data management application and/or the DevOps person interfaces with a load-balancing mechanism (e.g., load balancer 114).

To accomplish synchronous replication between sites, a low latency I/O path (e.g., with ~10 mS latency) supports continuous synchronous data exchanges between storage resources at both locations, thus enabling zero data loss replication and recovery, even in a disaster situation. Moreover, FIG. 1B depicts one way that a containerized data management application can facilitate coordination across sites by providing dynamic control over workload placement, replication mode, policy observation, policy synthesis use of expressed intents, and failover behavior within the active system architecture.

Further details regarding general approaches to policy observation, policy synthesis, and use of expressed intents are described in U.S. patent application Ser. No. 18/819,997 titled “ZERO-CODE ADMINISTRATION OF DATA MANAGEMENT FOR CONTAINERIZED WORKLOADS” (Attorney Docket No. NUT-PAT-1549), filed on Aug. 29, 2024, which is hereby incorporated by reference in its entirety.

As used herein, the term “data management application” and the term “data management function” are used interchangeably with the understanding that a data management application can implement a single data management function, or can implement a series of data management functions. Moreover, a single data management function can be, and indeed might need to be, implemented across multiple data management applications that interoperate between themselves to carry out the data management function or functions.

As used herein, intents are expressions of a particular desired behavior of a collection of executable units that run in a virtualization environment.

Once both the primary site and the secondary site are in suitable state, a series of virtualized entity migrations (e.g., to accomplish VE cloning) take place (e.g., such as the shown virtualized entity VE₁, virtualized entity VE₂, . . . virtualized entity VE_{N}). It should be noted that although a user application 106₁ is populated with the foregoing virtualized entities that are actively carrying out operations of the user application, the shadow virtualized entities that are shown within user application 106₂ are indeed shadow (inactive) virtualized entities. While they are configured to be able to be made active upon command, and while the Kubernetes cluster residing at the secondary site is sized to facilitate powering-up upon command they are initially dormant. As such, even though these shadow virtualized entities are present (e.g., as clones of a corresponding virtual entity in the primary site), they are there primarily to reserve an appropriate amount of computing resources that might be needed in the event of a switchover due to, for example, a disaster affecting the primary site.

The foregoing discussion of FIG. 1A and FIG. 1B pertains to merely some possible embodiments and/or ways to implement the foregoing advances to the underlying technologies. Many variations are possible, for example, the advances the technologies as comprehended in the foregoing can be implemented in any environment, examples of which are shown and described as pertains to the appended figures and corresponding written description.

FIG. 1C and FIG. 1D illustrate various technological improvements that apply to an active high availability data management application that runs on a geographically distal Kubernetes virtualization system. In particular, FIG. 1C introduces the existence of containerized storage instances (shown as C₁, C₂, . . . , C_{N}) that correspond to a containing virtualized entity. The (virtualized) containerized storage instances are backed by actual storage devices such the shown storage facility 1121 and storage facility 112₂. In this embodiment, the virtualized entities can correspond to any executable unit (e.g., a pod) within the Kubernetes environment. Further, the containerized storage instances may be those of a nature that are formed through use of a containerized storage interface (CSI).

FIG. 1D introduced still further advances, namely, the existence of volume groups (e.g., volume group VG₁, volume group VG₂) within a storage facility 1121. The existence of said volume groups is merely to introduce one species of particularly-configured storage. For emphasis, this is merely to illustrate how the generic facility of storage can be implemented using any known-in-the-art storage regime. Strictly as one further species, the generic facility of storage can be provided by a public (or private) cloud provider.

Now, again referring to the species of storage in the form of a volume group, it is now to be understood that (1) synchronous replication of volume groups can take place across sites, and yet be managed by a single volume group manager; (2) synchronous replication of volume groups can take place even when the volumes are used as guest attachments as might be configured by an virtualized entity; (3) when synchronous replication is enabled for a multi-volume application, crash-consistent snapshots are supported, although crash-consistent snapshots of constituent volumes in an asynchronous replication group may not be supported without additional capabilities not shown in the foregoing figures; (4) there is no requirement for a witness to be present since an orchestrated automatic unplanned failover of the application may take place over the synchronously-replicated volume groups; and (5) some embodiments provide for still further configuration replication facilities (e.g., asynchronous replication to a still further site).

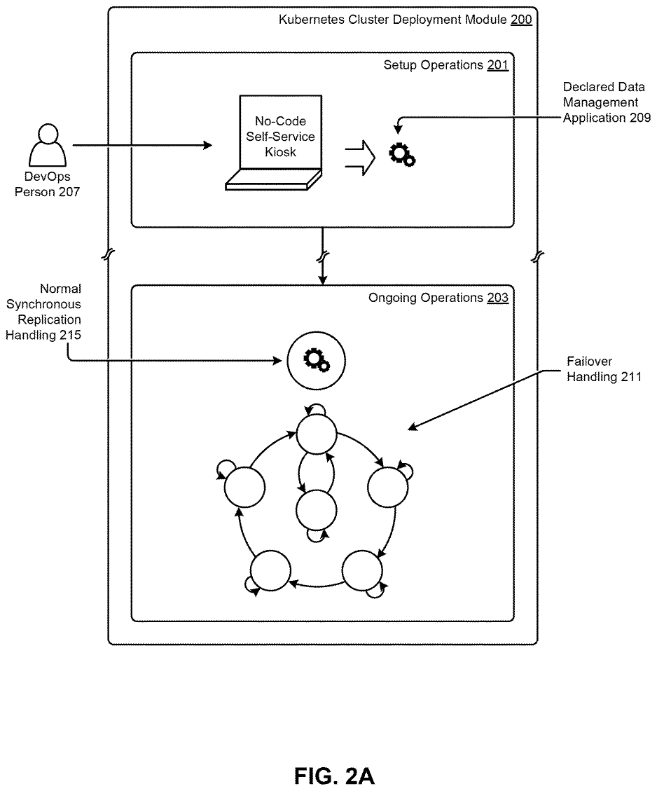

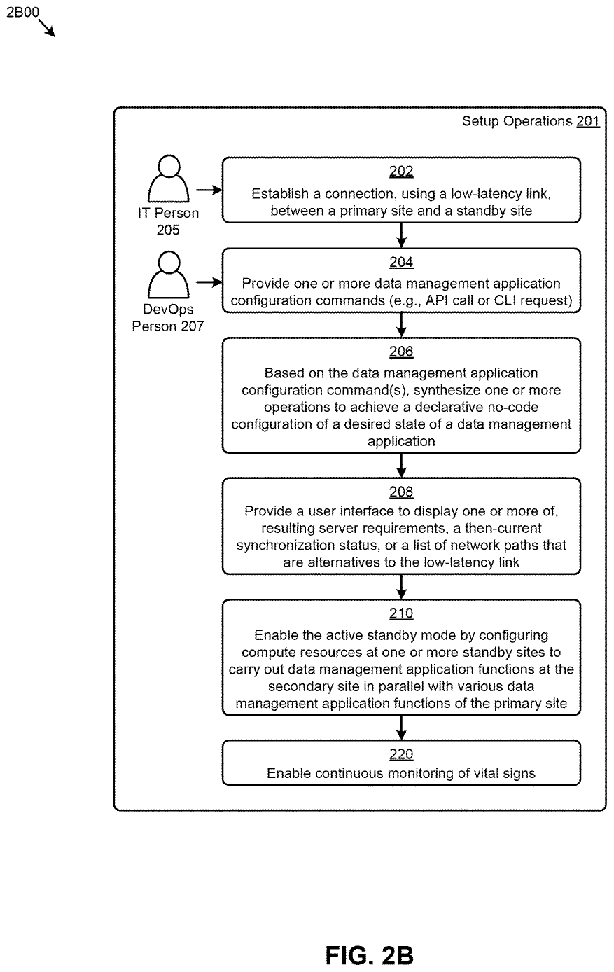

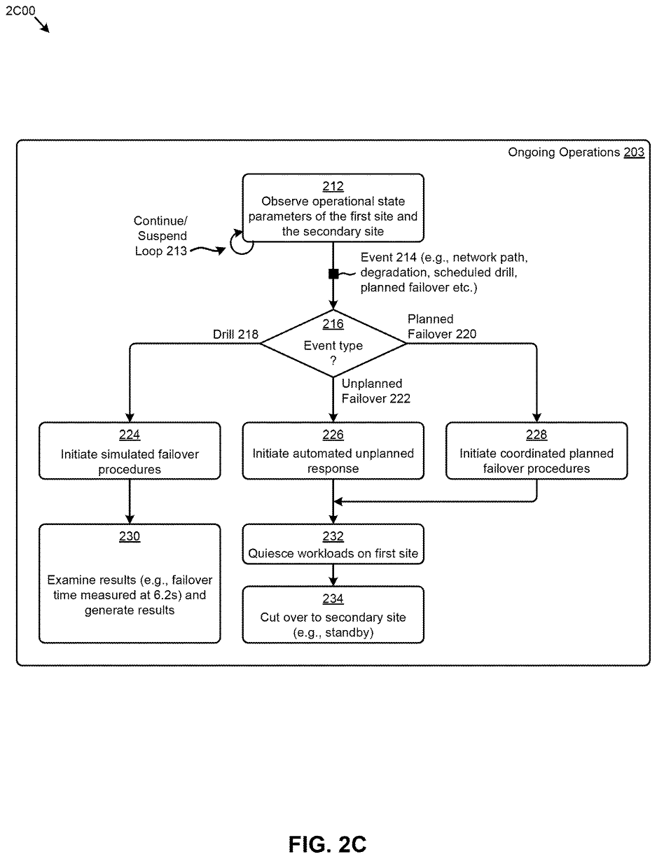

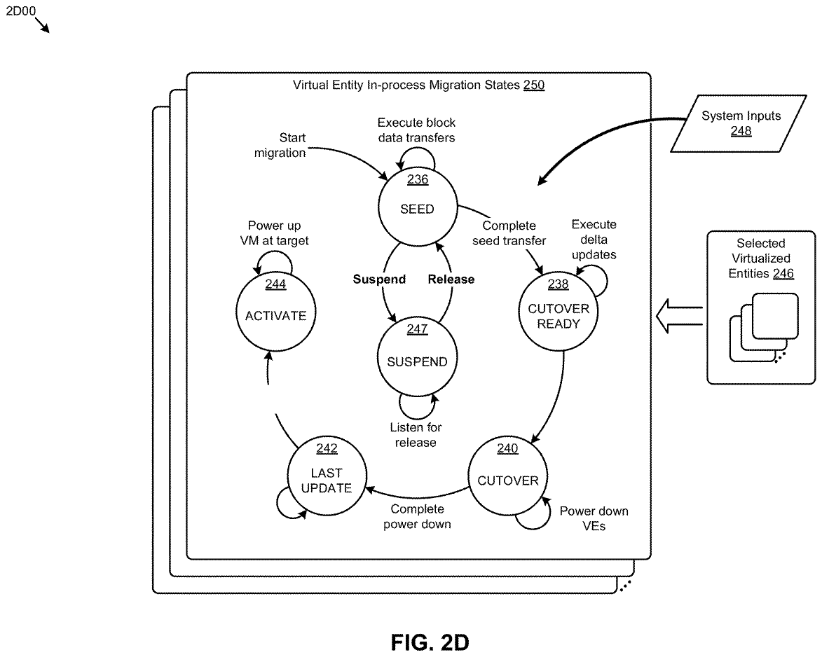

FIG. 2A depicts a Kubernetes cluster deployment module 200 as including setup operations 201 and ongoing operations 203 that implement a declarative no-code technique for deploying and maintaining an active high availability data management application. The figure depicts a DevOps person 207 who can interact with a no-code, self-service kiosk to cause the kiosk to generate a declared data management application 209. The figure also shows how said declared data management application 209 can operate continuously so as to implement the data management application. As shown, the ongoing operations 203 include normal synchronous replication handling 215 as well as failover handling 211. Detailed descriptions of both the setup operations and ongoing operations as well as detailed descriptions of various scenarios are described hereunder and in the accompanying figures.

FIG. 2B is a flowchart depicting setup operations for deploying an active high availability data management application. As an option, one or more variations of flowchart 2B00 or any aspect thereof may be implemented in the context of the architecture and functionality of the embodiments described herein and/or in any environment.

FIG. 2B is presented to illustrate a sequence of setup operations for establishing an active configuration across geographically distributed sites. The flowchart depicts the flow whereupon establishing a connection to a standby site, and after processing commands to establish a data management application, a user interface is presented to confirm or ratify configuration parameters. Upon confirmation or ratification of said configuration parameters, the active configuration is enabled such that computing resources at the standby site are available to be able to operate over the synchronously-replicated storage. The purpose of presenting FIG. 2B is to provide an overview of how an IT person 205 and a DevOps person 207, either individually or together, are able to bring up a secondary site in a declarative no-code configuration.

The discussion that follows as pertaining to FIG. 2B offers merely some possible embodiments and/or ways to implement setup operations. As shown, the flow corresponding to setup operations 201 commences when, at step 202, an IT person establishes a low-latency network connection between a primary site and a secondary site. Once such a low-latency network connection has been established in that DevOps person 207 is able to interact with step 204 to provide a data management application configuration specification via a series of commands, some of which commands are particularly configured to interpret any parameters and/or parameter values as may be provided. Implementation of a data application configuration command may take the form of an API call or a CLI request, or via some series of operation performed over some sort of user interface.

Upon having a data management application configuration available in some codified manner, for example as a data structure, step 206 serves to synthesize any number of computer-implementable operations so as to achieve manifestation of a declarative no-code configuration that meets the desired state of the subject data management application. At some point, it will happen that the declarative no-code configuration of the data management application is sufficiently in place such that a user interface may be provided (step 208) to display findings that came about during the course of implementing the declarative no-code configuration. Strictly as one example, such a user interface may display the determined server requirements, determined storage requirements, any aspects of the then current synchronization subsystem status, and possibly a list of network paths that are alternatives to the aforementioned low-latency link, etc. This user interface can be used for the DevOps person to ratify the configuration.

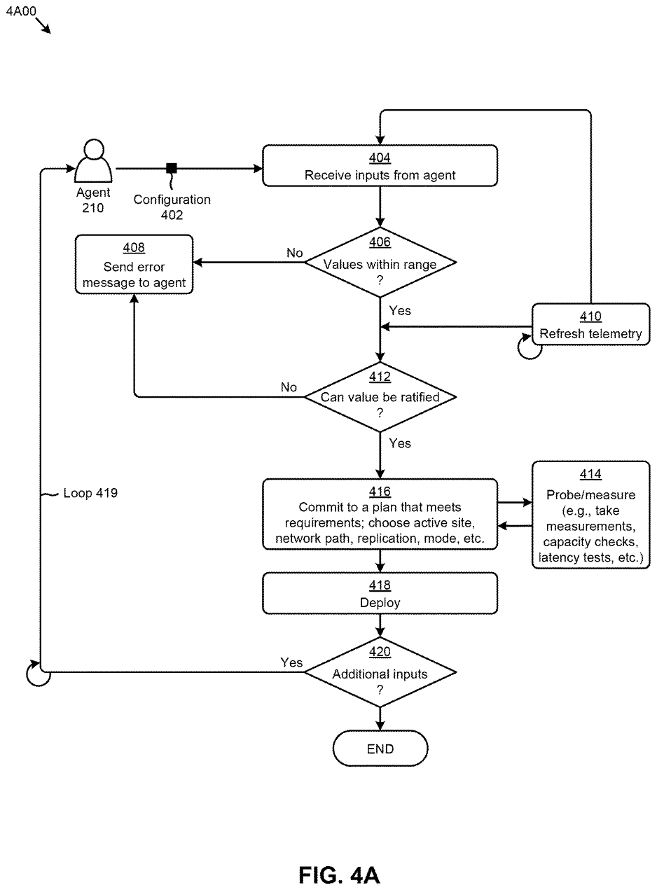

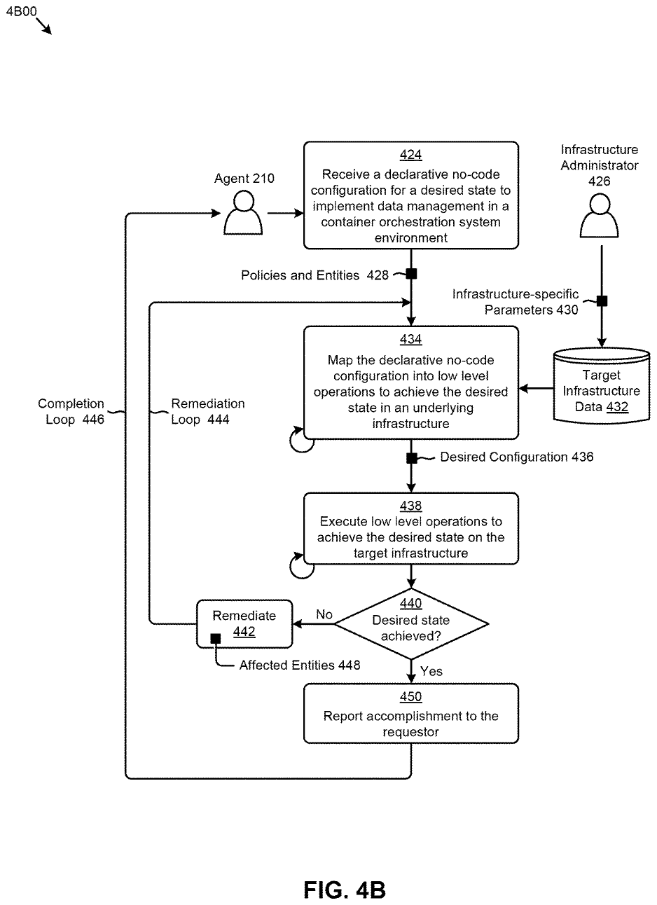

There are many more ways for establishing a declarative no-code configuration of a desired state of a data management application, however so as not to occlude the instant discussion regarding setup operations, further details regarding alternate ways for establishing a declarative no-code configuration of a desired state of a data management application are deferred until FIG. 4A and FIG. 4B.

Once the DevOps person has ratified or otherwise given a green light to the then current status as may be displayed in the foregoing user interface, the DevOps person is given the opportunity to enable the active standby mode. In some cases, the compute resources at one or both of the primary site or the secondary site are specifically configured to carry out the functions of the foregoing data management application. In this manner, data integrity can be guaranteed, at least inasmuch as having an active standby mode backed by synchronously replicated data implies that the data management application can be brought to and operational state at the secondary site nearly immediately upon detection of loss of facility of the primary site.

To accommodate knowing when there is a loss of facility at the primary site, step 210 (to enable standby mode), and step 220 (to provide continuous monitoring) serve to establish and maintain continuous monitoring of vital signs of the primary site. It should be noted that the foregoing loss of facility might be a result of some particular disaster that affects the servers or the data center more generally at the primary site, or it might be that merely the communication link between the primary site and the secondary site has experienced some loss of functionality. As such, beyond merely monitoring of vital signs, a monitoring facility is able to raise alerts to any listener. Strictly as one example, the load balancer 114, and/or the overseer 115 is able to be configured as a listener for vital signs. Based on the severity of the alert, the load balancer and/or the overseer can initiate remediation.

Now, returning to the discussion of step 210, it should be noted that the virtualized entities as discussed in FIG. 1B, FIG. 1C, and FIG. 1D are virtualized entities (e.g., pods) that are situated within a Kubernetes environment. As such when carrying out the operations of step 210, and/or when carrying out the operations of step 206, it often happens that Kubernetes clusters are provided with sufficient information such that the virtualized entity is aware of the storage provider and whatever mechanisms are provided by the storage provider in order to configure storage that is managed by Kubernetes clusters. In some cases, Kubernetes semantics such as custom resource object models are defined and/or accessed. Still further and still within the Kubernetes environment, the foregoing volume group synchronous replication is established together with protection policies and recovery plans. Such protection policies and recovery plans may have been specified by the DevOps person is interacting with the flow of FIG. 2B (e.g., when establishing the computing facility configuration of either the primary site and/or the secondary site).

FIG. 2C is a flowchart depicting ongoing operations for maintaining states of an active high availability data management application. As an option, one or more variations of flowchart 2C00 or any aspect thereof may be implemented in the context of the architecture and functionality of the embodiments described herein and/or in any environment.

FIG. 2C is presented to illustrate an example sequence of ongoing operations that occur after initial setup to maintain and verify high-availability behavior across distributed sites. The flowchart depicts how operational state parameters of a first site (e.g., primary site) and a second site (e.g., secondary site) are continuously observed, and how detected events trigger different response paths depending on the event type. The configuration supports planned failover, unplanned failover, and simulated (e.g., drill) failover modes, thereby enabling both validation of recovery readiness under controlled conditions and automative responses to unexpected disruptions. In some implementations, the operations may include automated failover tests and subsequent analysis of recovery performance. Additional steps may involve quiescing virtual machine workloads at the first site then cutting over to the secondary site for continued operation. The purpose of presenting FIG. 2C is to demonstrate how the disclosed system accommodates both proactive and reactive recovery scenarios, thus allowing testing, validation, and execution of failovers within a unified active configuration.

The flow 2C00 as depicted in FIG. 2C is a possible embodiment of ongoing operations 203. In this particular embodiment, step 212 serves to gather the operational state of the system. This gathering is typical of ongoing monitoring that continually seeks to determine if the ongoing monitoring should continue or should be suspended (loop 213), or should exit the monitoring based on observation of some event (e.g., event 214).

When it is deemed that there is a reason for the monitoring to emit an observed event (e.g., event 214) step 212 can both (1) emit said event, and (2) continue gathering even while the event is bring processed downstream. Strictly to highlight three examples of event 214, consider (case 1) that there may be some indication that a network path is “down” or for some reason unreachable, or gravely degraded so as to impede normal processing, or (case 2) there is a planned failover that is approaching readiness to be enacted, or (case 3) there is a scheduled drill operation (e.g., which raises a simulated failover event) that is approaching.

In the latter case, the left branch of decision 216 (which branch is shown as drill 218) is taken and simulated failover procedures are initiated (step 224). Step 230 then serves to consider the results of said simulation. Results of a series of drills can be compared so as to identify areas that were improved from drill-to-drill as well as to identify areas that are in need of improvement as evidenced from objective measurements taken in the drills and then compared drill-over-drill.

In the case of a planned failover, the right branch of decision 216 (which branch is shown as planned failover 220) is taken and planned failover procedures are initiated (step 228). Step 232 then serves to quiesce workloads at a first site (step 232) and cut over (step 234) to a secondary site. It should be noted that the workload impact of a planned failover can be mitigated by judicious scheduling (e.g., whether as a result of automated scheduling or whether as a result of human-influenced scheduling) so as to avoid having any mission-critical workloads in process at the time of the scheduled failover.

The figure depicts one more case, specifically when the bottom branch of decision 216 (which branch is shown as unplanned failover 222) is taken. In this case, step 226 serves to initiate any sets of actions that collectively comprise automated migration and/or further automated responses to an unplanned failover event.

It sometimes happens that even though prior decision-making deems that the conditions warrant an unplanned failover (e.g., from a first site to a secondary site), it is still possible to quiesce activities at the first site before setting about to cause the cutover to the secondary site. To accommodate such situations, step 232 serves to quiesce activities at the first site. Of course, there are many disaster scenarios where it is not possible to quiesce activities at the first site (e.g., because the first site is utterly unreachable) before setting about to cause the cutover to the secondary site, in which case there may be no possibility to carry out the operation of step 226, in which case processing flows to step 234 which then causes the cutover to take place.

The foregoing discussion of FIG. 2C pertains to merely some possible embodiments and/or ways to implement real or simulated failovers. Many variations are possible, for example, the operation of step 226 as comprehended in the foregoing can be implemented to handle any types of computing entities, including virtualized entities in a virtualized environment. More particularly, it sometimes happens that there are virtualized entities (e.g., Kubernetes workloads) that are not being handled by the foregoing data management application, but nevertheless need to be dealt with in the event of some loss of functionality.

FIG. 2D presents one example of a state chart depicting the transitioning of Kubernetes workloads between Kubernetes clusters during a cutover operation. As an option, one or more variations of state chart 2D00 or any aspect thereof may be implemented in the context of the architecture and functionality of the embodiments described herein and/or in any environment.

FIG. 2D is presented to illustrate an example state diagram showing in-process migration operations for virtualized entities during handling of events such as either a live failover event (“this is not a drill”) or simulated (“this is a drill”) failover event. The figure depicts the various states that a virtual machine may transition through when executing (for example) block data transfers, applying delta updates, performing a final cutover between sites, etc. Of particular note, certain phases of the migration process-such as the final or “last update” phase—can be traversed in a simulated mode or drill mode to evaluate system performance without altering operational data. In modes involving simulated orchestration and timing sequences, the system seeks to perform the same or similar orchestration and timing sequence as a real failover, but suspends execution of operations that would cause irreversible state changes.

One aspect pertaining to modifying aspects of a cutover (e.g., in response to receipt of system inputs 248), comprehends that the in-process migration states of the virtualized entities 246 correspond to a particular workload. To explain, the figure illustrates the set of possible in-process migration states associated with any particular virtualized entity being migrated, and how such states are modified (e.g., by a state transition) in response to received user inputs and/or other conditions that are detected while the migration is in process.

As shown in FIG. 2D, a respective set of VE in-process migration states 250 correspond to each of a set of selected virtualized entities 246 (e.g., executable containers, VMs, etc.) that are selected for migration during a failover. The set of VE in-process migration states for each VE of selected virtualized entities 246 comprise six states: a “SEED” state (state 236), a “CUTOVER READY” state (state 238), a “CUTOVER” state (state 240), a “LAST UPDATE” state (state 242), an “ACTIVATE” state (state 244), and a “SUSPEND” state (state 247).

In response to an event (e.g., a “Start migration” event), a VE enters the “SEED” state, at which time instances of block data transfers will be executed to migrate seed data associated with the VE to the target environment. When the seed transfer is completed, the VE transitions to the “CUTOVER READY” state. In this state, updates (e.g., deltas) to the seed data and/or the then-current migrated data are continually transferred to the target environment.

While the “SEED” state is often the most time-consuming and resource-consuming state, a VM in the “CUTOVER READY” state might be contending with other VEs for computing resources (e.g., other VEs in respective “SEED” states, and/or other VEs that reach “CUTOVER READY” states, etc.), thereby often incurring a long and/or at least uncertain latency before completing the migration (e.g., upon reaching the “ACTIVATE” state). Furthermore, the effects of such uncertain and long cutover latencies are exacerbated when migrating a VE across environments with different infrastructure, since the VE might need to be unavailable (e.g., powered down) during some portions of the cutover. More specifically, when migrating a VE across environments with different infrastructure, the migration might include steps for (1) powering-down the VE so that no further inputs or outputs (I/Os or IOs) can be initiated, (2) transferring all of any remaining non-volatile data of a VE to the target environment, and (3) powering-up the VE in the target environment such as is depicted in FIG. 2D as pertains to the ACTIVATE state.

There might be incompatibilities between memory images of different infrastructure types, and/or incompatibilities between virtual entity representations on different infrastructure. For example, a Kubernetes module or a hypervisor at a target computing environment might support specialized disk controllers and/or specialized network interfaces that were not present at the source computing environment. As such, migration of a VE to a target computing environment that hosts an infrastructure type that is different from the infrastructure type at the source computing environment might include a reboot of the VE at the target computing environment such that the VE can discover the hardware configuration of the target computing environment during its boot-up and initialization phase.

When a power down of the subject VE is initiated, processing within the “CUTOVER” state waits until the VE has completed its power down cycle. In some cases, there may be many tasks to complete in a power down cycle of a VE, and as such a possibly long time (e.g., many seconds) may elapse before achieving a complete power down of the VE. After achieving a complete power down of the VE at the source computing environment, the subject VM transitions to the “LAST UPDATE” state, at which time the last data update (e.g., delta) is transferred to the target computing environment. An instance of the subject VM is then powered up at the target computing environment in the “ACTIVATE” state. In response to the subject VM reaching the “ACTIVATE” state, the other VMs can be transitioned (see “Release” transition) back to the “SEED” state. In most embodiments, change block tracking of the seed data transfer is implemented to facilitate picking up the seed data transfer at the last block transferred prior to being suspended.

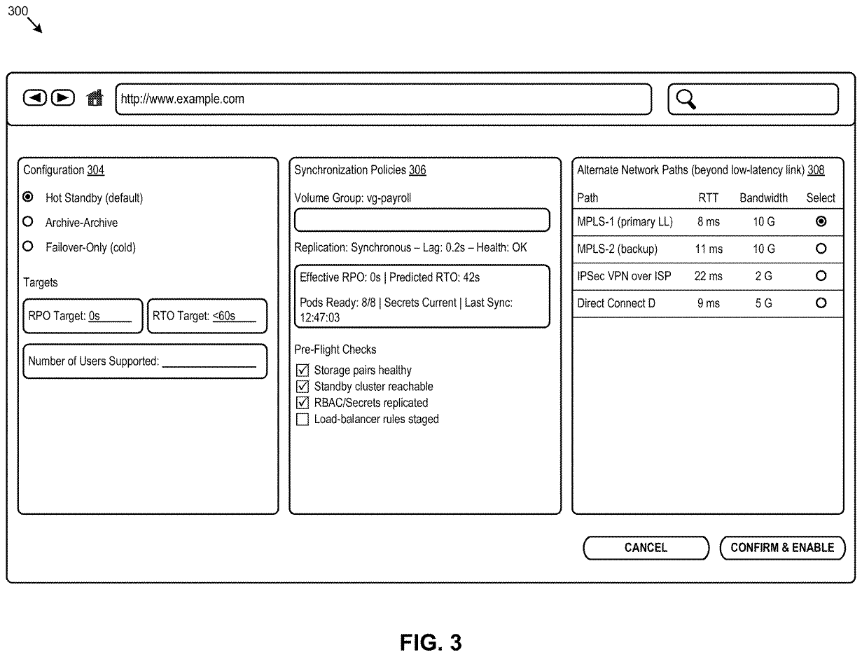

As mentioned above, it sometimes happens that there are virtualized entities (e.g., Kubernetes workloads) that are not being handled by a data management application, but nevertheless need to be dealt with in the event of some loss of functionality. Such situations have been contemplated, at least to the extent that user interfaces-such as the user interface depicted as pertains to FIG. 3—can be shown and discussed as follows.

More specifically, the imagery of FIG. 3 illustrates a user interface for configuring high-availability parameters and synchronization policies of a data management application in Kubernetes. As an option, one or more variations of user interface 300 or any aspect thereof may be implemented in the context of the architecture and functionality of the embodiments described herein and/or in any environment.

FIG. 3 is presented to illustrate an example of a graphical interface to configure and justify high-availability parameters for a data management application operating across distributed Kubernetes sites. The interface include a configuration panel 304 (shown as Configuration), which configuration panel permits GUI-enabled entry of macro-architecture (e.g., “Hot Standby”, “Archive-Archive” or “Failover Only” options) as well as specification of recovery objectives. As shown, a second panel 306 addresses synchronization policies and replication statuses, (e.g., by presenting real-time indicators of system health and pre-flight validation results). Further, the interface includes a third panel 308 for specifying how two sites are to be network interconnected.

Through this interface, an agent can select desired failover and confirm readiness prior to enabling for ongoing operations. The GUI of FIG. 3 exemplifies how configuration, validation, and synchronization policy selection can be integrated into a single workflow element, thereby reducing manual complexity and ensuring that high-availability settings comply with operational and service-level requirements before activation.

The foregoing user interface of FIG. 3 is merely an example, and pertains to merely some possible embodiments and/or ways to implement such a user interface. Many variations are possible, for example, the user interface as comprehended in the foregoing can be implemented in any environment, and/or be handled in a wide variety of computer processing configurations, one example of which is shown and described hereunder.

FIG. 4A depicts a flowchart that describes operations and decisions that a user interface handler might process. The flow includes mechanisms for processing the provided inputs, determining whether the inputs can be ratified, and deploying ratified configurations within a Kubernetes-based data management application. As an option, one or more variations of user interface handler 4A00 or any aspect thereof may be implemented in the context of the architecture and functionality of the embodiments described herein and/or in any environment.

FIG. 4A is presented to illustrate an example sequence of operations performed by an agent (e.g., user-interface handler) that validates, ratifies, and deploys configuration inputs received from an agent or automation process. The flowchart shows how input values are evaluated against acceptable ranges, how telemetry or probe data may be refreshed to confirm environmental conditions, and how ratified parameters are committed into a deployment plan. The process ensures that only inputs meeting operational and replication requirements are applied to the data management environment and, as such, configuration, validation and ratification are also integrated into the data management environment, thereby preventing invalid or non-compliant settings from propagating to the live Kubernetes cluster and thereby ensuring that the resulting deployment is configured to as to be able to operate within certain (e.g., user-defined) service-level contours.

As shown, a SysOps person or a DevOps person (e.g., agent 210) defines a configuration 402 that is in turn received (step 404) in a manner such that the configuration can be vetted for sensibilities by value checking. In this embodiment, such value checking is carried out within decision 406. If said values are deemed to be outside of permitted ranges, then the “No” branch of decision 406 is taken and subsequent operations serve to raise an error or commence to carry out remediation (step 408). On the other hand, if the checking of decision 406 deems that the values are in range, then the “Yes” branch of decision 406 is taken and further checking is initiated.

In some cases, after range checking, but before the next ratification (e.g., within decision 412) it might happen that environmental telemetry needs to be updated. Accordingly, operation 410 is provided to refresh telemetry, which refresh can be performed asynchronously with the steps of user interface handler 4A00. In some cases, the values in the refreshed telemetry are such that the entire flow is restarted de novo.

Assuming that the in-range value (or values) can be ratified (decision 412) then the “Yes” branch of decision 412 is taken and processing commences to develop a plan (step 416) and deploy said plan (operation 418), which plan development and deployment are now briefly discussed.

The activities of step 416 often involve updating environmental conditions, which updating may be facilitated by probing and measurement taking (facility 414) in a manner that facilitates automated generation of a plan. To explain by example, the user might ask (e.g., via the user interface of FIG. 3) for a secondary site to support 10,000 users. This might be possible, however on the other hand, it might not be possible given whatever information the measurement taking of facility 414 uncovers. In such a situation, the number of users supported might be automatically reduced so as to come up with a deployment plan that can be actually realized. Assuming that step 416 does resolve to a deployment plan that can be actually realized, then deployment of the plan is initiated (at step 418).

As one of skill in the art may recognize, it can happen that even if a putatively deployable plan is committed to (step 416), it can happen that during deployment, there is new information that is uncovered. In some cases, the newly-uncovered information might be of a nature that would suggest a replan. To accommodate that possibility, decision 420 and loop 419 are configured such that if the newly-uncovered information does indeed suggest a replan, then the “Yes” branch of decision 420 can be taken (onto loop 419) and agent 210 can, either automatically or in a human-assisted manner, enter the flow afresh using at least some aspects of the newly-uncovered information that are codified into configuration 402.

The foregoing discussion of FIG. 4A pertains to merely some possible embodiments and/or ways to implement a user interface handler. Many variations are possible. For example, the user interface handler as comprehended in the foregoing can be implemented in any environment. In particular, there are certain environments known as “No Code” or “Low Code” environments where an agent needs to merely kick off a configuration with a series of declarations (e.g., of a desired state). One way to implement such a “No Code” or “Low Code” high availability data management application in Kubernetes is shown and described as pertains to the FIG. 4B.

FIG. 4B depicts a flowchart for mapping a declarative configuration request into infrastructure-level operations so as to achieve a desired state of a computing cluster. As an option, one or more variations of 4B00 or any aspect thereof may be implemented in the context of the architecture and functionality of the embodiments described herein and/or in any environment.

FIG. 4B is being presented to illustrate an example sequence of operations for converting a declarative configuration into executable infrastructure-level actions that bring a system to a desired operational state. The flowchart shows how a configuration request received through a no-code interface is interpreted, mapped into specific low-level operations, and applied to the target infrastructure. The process includes iterative monitoring and remediation cycles to verify whether the desired state has been achieved, automatically reapplying or adjusting operations when necessary. The purpose of presenting FIG. 4B is to demonstrate how the disclosed system maintains alignment between high-level configuration intent and the underlying infrastructure through a continuous feedback and remediation loop, thereby ensuring that the deployed environment converges toward and sustains the administrator-defined desired state.

FIG. 4B shows a technique to implement zero-code administration of data management for containerized workloads. The figure depicts an operation flow 4B00 that results in accomplishment of bringing up a data management application. This particular flow is initiated by an application manager such as a DevOps person (e.g., the shown agent 210). In this flow, the application manager provides inputs, possibly using all or portions of a graphical user interface, so as to provide inputs into the flow (at step 424). The inputs may be in the form of a declarative no-code configuration for a desired state to be achieved in a container orchestration system. In some cases, and as shown, the declarative no-code configuration includes policies and entities 428, any of which may be provided as inputs and/or produced as (possibly modified) outputs. At step 434, the declarative no-code configuration is mapped into computer-implementable operations (e.g., API calls) that, either singly or in combination with other computer-implementable operations, serve to foster achievement of the desired configuration 436 on some particular computing infrastructure.

More specifically, the desired state is achieved within or across or coordinated via any number of executable containers of the identified container orchestration system. The processing of step 434 can be informed by the shown target infrastructure data 432, which may in turn be informed by any one or more infrastructure-specific parameters 430. It sometimes happens that infrastructure administrator 426 can specify infrastructure-specific parameters. Additionally or alternatively, infrastructure-specific parameters can be automatically generated.

One possible result arising from the processing of step 434 is a set of infrastructure-specific intents and/or low level operations which, singly or in combination, serve to achieve the desired state on the target infrastructure. Such achievement may require multiple iterations through step 438. Accordingly, decision 440 serves to check if the desired state has been achieved. In some cases, it is merely a matter of time before the desired state is achieved. In other cases, some remediation is needed. As such, when the “No” branch of decision 440 is taken, step 442 serves to remediate the fact that the desired state has not yet been achieved. This is accommodated by providing a remediation loop 444. In some cases, the remediation step modifies parameters for or of affected entities 448.

When the desired state is achieved, the “Yes” branch of decision 440 is taken and the accomplishment is reported (step 450) to the agent (e.g., via the shown completion loop 446). In subsequent processing (e.g., as per sequential processing) or in any downstream processing (e.g., as per parallel processing), there may be a further desired state, and a second further desired state after that, and so on.

The foregoing technique to implement zero-code administration of data management for containerized workloads can be practiced in any environment and/or in correspondence to any sort of data management scenario and/or in accordance with any deployment scenario.

Further details regarding general approaches to computing cluster bring-up using expressed intents are described in U.S. Pat. No. 12,461,792 titled “COMPUTING CLUSTER BRING-UP ON PUBLIC CLOUD INFRASTRUCTURE USING EXPRESSED INTENTS” issued on issued on Nov. 4, 2025, which is hereby incorporated by reference in its entirety.

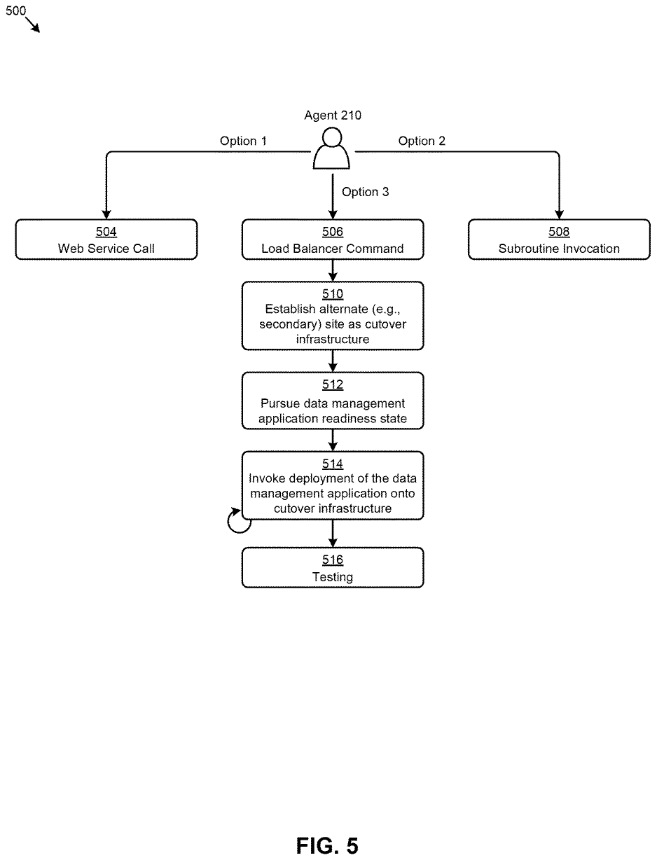

The foregoing discussion of FIG. 4B pertains to merely some possible embodiments and/or ways to bring a system to a desired operational state. Many variations are possible, for example, the techniques for bringing a system to a desired operational state as comprehended in the foregoing can be implemented in any environment, one example of which is shown and described as pertains to FIG. 5.

FIG. 5 presents an example of an agent-directed data management application deployment. As an option, one or more variations of user interaction technique 500 or any aspect thereof may be implemented in the context of the architecture and functionality of the embodiments described herein and/or in any environment.

FIG. 5 is presented to illustrate an example of how agent 210 or an automation agent can initiate the process of establishing a cutover site through multiple computer-implemented mechanisms. The flowchart shows that the cutover operation can be triggered using (1) a web service call, (2) a load-balancer command, or (3) a subroutine invocation, each of which results in the establishment of an alternate site to serve as the new active infrastructure. Once initiated, the sequence advances through a readiness phase and subsequently invokes deployment of the data-management application onto the cutover site. The purpose of presenting FIG. 5 is to demonstrate that the disclosed system supports flexible and user-selectable initiation options for activating a secondary site or a recovery site, thereby enabling integration with existing automation frameworks, command interfaces, and orchestration tools, while maintaining consistent deployment behavior across all invocation modes.

As shown, agent 210 might choose from among several options (e.g., option 1, option 2, or option 3) that correspond to different mechanisms to deploy and invoke a data management application onto a secondary site. As shown, the options correspond to web service call 504 (option 1), load balancer command 506 (option 3), or subroutine invocation 508 (option 2) (e.g., from an applet or script). Irrespective of which option might be selected, processing moves to the flow of establishing an alternate site as a cutover site (step 510), bringing up a data management application to a readiness state (step 512), which bring-up might entail bring-up using expressed intents invoking the data management application (step 514) so as to commence ongoing operations of one or more Kubernetes-based high availability data management applications, and/or to commence testing of the deployment (step 516). In some cases the aforementioned testing uses the aforementioned drill capability.

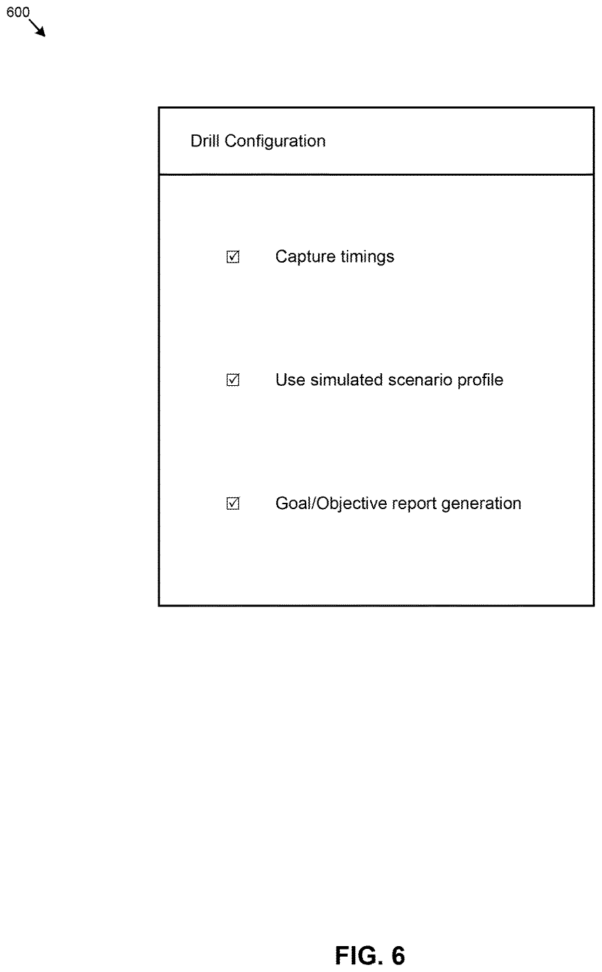

FIG. 6 is presented to illustrate a user interface 600 as used in configuring a drill capability, which can then be used to test readiness of an active deployment of a data management application in a Kubernetes environment.

The shown user interface facilitates drill configuration for an active deployment across geographically-separated environments. In the illustrated embodiment, the interface includes selectable fields (e.g., check boxes) for capturing drill-related user options such as execution and response timings, and for selecting whether to use a predefined or simulated scenario profile. The interface may also include controls for generating a goal or objective report, thereby allowing users to validate configuration accuracy, measure recovery performance, and document drill outcomes. The configuration interface provides an intuitive mechanism for initiating, monitoring, and analyzing drill activities without requiring manual scripting or command-line execution.

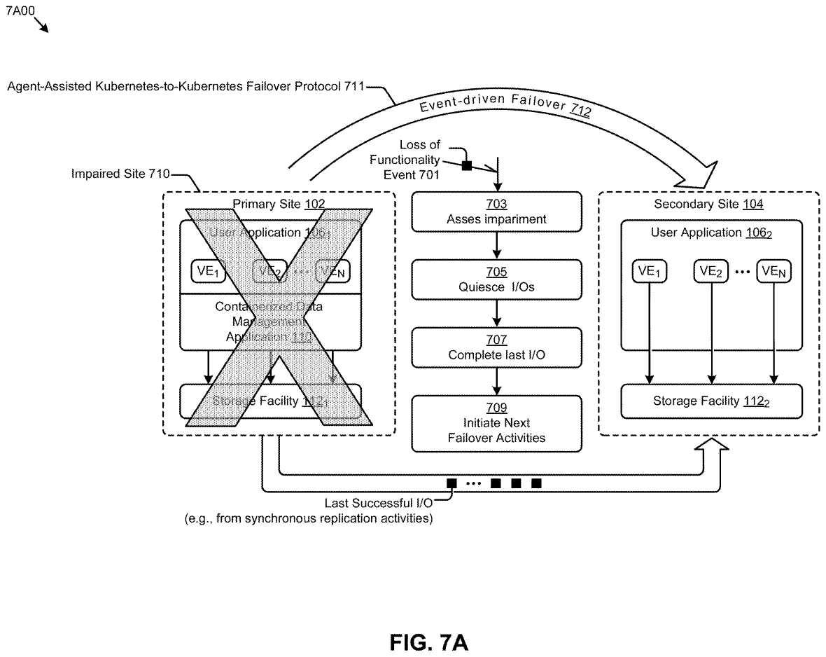

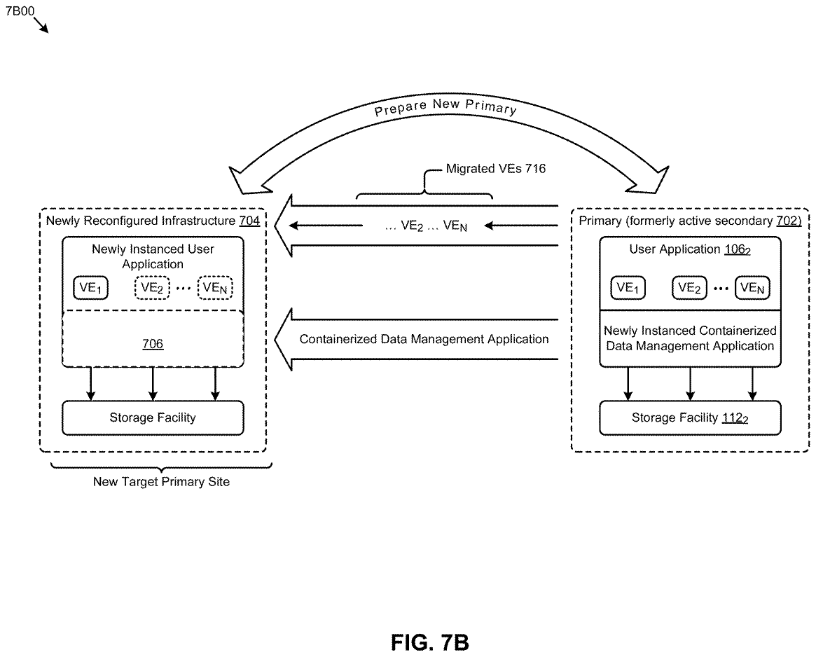

FIG. 7A exemplifies an event-driven failover scenario in which active virtual entities of an alternate site become the primary virtual entities. As an option, one or more variations of event-driven failover scenario 7A00 or any aspect thereof may be implemented in the context of the architecture and functionality of the embodiments described herein and/or in any environment.

FIG. 7A is presented to illustrate how an example event-driven failover 712 is accomplished. In this example, an impairment at a first site (e.g., primary site 102) triggers a controlled transition of operations so as to move said operations to a second site (e.g., secondary site 104). The figure shows that the system responds to a fault condition (e.g., via loss of functionality event 701) and then proceeds to assess the nature of impairment (step 703). Assuming the fault condition is not merely a transient, then, in this example, the flow initiates quiescence (e.g., via step 705 to quiesce I/O operations), so as to safely complete outstanding I/O operations (e.g., via step 707 to complete a last I/O), and then initiates next failover activities (e.g., via step 709), in this case by invoking an agent-assisted Kubernetes-to-Kubernetes failover protocol 711. Continuing, the heretofore-described Kubernetes cluster deployment module (e.g., the Kubernetes cluster deployment module 200 of FIG. 2A) is invoked so as to cause a newly instanced containerized data management application to be made operational at the secondary site. In exemplary configurations, said newly instanced containerized data management application is made operational at the secondary site through use of the foregoing declarative no-code configuration capabilities of the Kubernetes cluster deployment module.

It should be recognized that dynamic use (e.g., upon or after a failure event) of a Kubernetes cluster deployment module becomes paramount when the infrastructure of the secondary site is not exactly congruent with the topology of the primary site, and/or when policies and/or governance does not apply to the infrastructure of the secondary site. In such a situation, it might be impossible to merely lift-and-shift the containerized data management application from the primary site to the secondary site. Rather a new instance of the containerized data management application would need to be constructed from the bottom-up, based carrying out low-level operations on the secondary site (i.e., which low-level operations were synthesized by expressed intents. Further details regarding general approaches to computing cluster bring-up using expressed intents are described in U.S. Pat. No. 12,461,792 titled “COMPUTING CLUSTER BRING-UP ON PUBLIC CLOUD INFRASTRUCTURE USING EXPRESSED INTENTS” issued on issued on Nov. 4, 2025, which is hereby incorporated by reference in its entirety.

Although the foregoing discussion pertaining to invoking a Kubernetes cluster deployment module is presented in the context of the failover operations of step 709, it should be recognized that invoking a Kubernetes cluster deployment module can be done anytime when there is a loss of functionality event. For example invoking a Kubernetes cluster deployment module can be done at some moment during or after step 703 determines the nature of the impairment.

As can now be seen, a loss of functionality event 701 triggers a sequence of operations that brings up a secondary site that is configured to deliver service continuity in spite of the nature or severity of the conditions that raised event 701 and/or that caused primary site 102 to become what is shown as impaired site 710. In this configuration, both sites participate in an active arrangement, at least to the extent of completing whatever turns out to be the last I/O, thus allowing the alternate site to immediately assume production responsibilities without manual intervention, and without loss of any synchronized data. The purpose of presenting FIG. 7A is to demonstrate how failover events are detected and how remediation steps are carried out in real time so as to preserve data integrity and operational availability. The figure as depicted provides a visual context for how the system transitions between active nodes within a distributed high-availability environment.

FIG. 7B exemplifies an event-driven failback scenario 7B00 in which the secondary site 104 of FIG. 7A is deemed to now be designated as primary site, and where a further new primary site is configured onto newly reconfigured infrastructure 704 such that virtual entities can be migrated to the newly reconfigured infrastructure. Doing so substantially returns the system to the topology that was present before the occurrence of event 701 (see FIG. 7A). As an option, one or more variations of event-driven failback scenario 7B00 or any aspect thereof may be implemented in the context of the architecture and functionality of the embodiments described herein and/or in any environment.

The figure depicts an embodiment in which the system prepares a site to be restored, possibly onto newly reconfigured infrastructure 704 to be staged as the new primary site, and to then to cause that site to carry out roles and actions as are applicable to a primary environment. This can be done while the currently-active primary (which was formerly the secondary site) is staged to operate as the standby or secondary location within the upcoming, soon-to-be operational dual-site active configuration. During this transition, synchronization and readiness checks may be performed to ensure that data consistency, replication integrity, and connectivity are preserved prior to reestablishing full active operation. The purpose of presenting FIG. 7B is to demonstrate how the disclosed system performs automated bring-up, automated recovery and automated reintegration of restored infrastructure into a synchronized configuration, enabling a seamless return to normal operations without manual intervention or disruption to application availability.

To further explain, communications to prepare a new primary are carried out between the primary site (formerly active secondary 702) and components of the shown newly reconfigured infrastructure 704, which newly reconfigured infrastructure might be a slight reconfiguration of what was the former primary site, or which newly reconfigured infrastructure might be over a collection of components that were drawn from a resource pool (e.g., resources offered by a cloud vendor). Once both the primary site (formerly active secondary 702) and the newly reconfigured infrastructure 704 are is a suitable state, a series of entity migrations (e.g., to accomplish VE cloning) take place such as the shown migrated VEs 716 (e.g., VE₂, . . . VE_{N}). At some point in time, all of the VEs are migrated over (but possibly not powered-up as of yet) and a still further newly instanced containerized data management application 706 (e.g., as shown by the dotted lines) is situated on the newly reconfigured infrastructure 704. The dotted lines and the naming convention of the VEs is there to illustrate that virtualized entities (VE₁, VE₂, . . . VE_{N}) are clones of corresponding ones of the virtualized entities of the other site.

The operational elements of newly configured infrastructure 704 can all now commence. This failback technique has thusly created a similar (or more advanced) primary site such as shown and discussed in FIG. 1B.

The foregoing discussion of FIG. 7B pertains to merely some possible embodiments and/or ways to implement an event-driven failback scenario. Many variations are possible, for example, the event-driven failback scenario as comprehended in the foregoing can be implemented in any environment, including in situations when an event-driven failback allocates and configures new infrastructure, which infrastructure is wholly non-overlapping with the infrastructure that suffered under conditions that precipitated the need for a failover. This situation models a true disaster (e.g., a flood or fire) where the infrastructure that suffered under the conditions that precipitated the need for a failover is deemed to be beyond remediation.

### Further Enablement of the Embodiments of the Disclosure

### Design for the Setup and Management of Active Standby High Availability (HA) Applications in Kubernetes Using a Containerized Environment

The disclosures herein show how a containerized environment can be used to set up a containerized environment application for high availability in an active/standby configuration across two Kubernetes clusters, each running on separate failure domains or geographical sites.

### Replication Point Objective (RPO)

Volume group synchronous replication is a zero-RPO replication technology provided by vendors of virtualization systems. The heretofore referenced technologies enable customers to run mission-critical enterprise workloads with the guarantee that disasters won't have any attendant loss of business-critical data.

Given the nature of the guarantee that volume group synchronous replication provides, the sites across which the replication is performed has a roundtrip network latency of not more than 10 ms. Higher latencies might have adverse impact on the performance of the application and consequently poor end-user experience.

### Containerized System Embodiments Using Kubernetes (K8s)

Disclosed herein are techniques for turning a single K8s application into a high availability application spread across two K8s clusters and making them work in tandem to provide for active/standby high availability setup that is aware of limitations that may be present in any particular embodiment (e.g., any limitations of the volume group synchronous replication features). A containerized environment that hosts a high availability application in an active/standby configuration can be paired to be setup across another K8s cluster (possibly on a different failure domain). Techniques as disclosed herein serve to configure multiple K8s clusters for working together in tandem to provide high availability for mission-critical applications.

In the active/standby configuration, the containerized environment provides support for one active site and will be the hosting/serving site for the application. To explain, in steady state operation, it is the active site that will host the running application. The standby site will secure the resources needed so as to be ready to be deployed either during planned migration or unplanned failover.

The various sections below will describe how one embodiment of the support for high availability application in a containerized environment can be built.

### Scope

There are many techniques for configuring K8 clusters for specific purposes. Some such techniques are shown and discussed as pertains to Table 1.

TABLE 1
Techniques for configuring applications for HA in K8s and corresponding evaluations

| Technique | Evaluation |
|---|---|
| Distributed | Distributed applications, which have support for replication of data built in the |
| applications (e.g., | application layer, can leverage topology-awareness feature(s) enabled by a |
| replicated | container storage interface driver. Leveraging this capability enables the |
| databases) | deployment of the distributed applications in a specified manner, whereby failure of |
| | replica(s) in a failure domain (due to failure of the domain) may not result in bringing |
| | down the entire application. |
| Highly Available | A single K8s cluster can draw worker nodes from different failure domains and, |
| K8s Control Plane | through the use of volume group synchronous replication and a controller, can |
| | enable high availability (HA) for applications that fall outside the category described |
| | just above. One advantage of this is that replicating the application configuration |
| | across multiple K8s clusters need not be performed. To explain further, consider the |
| | following example where (for example) if the storage from one of the failure |
| | domains were to go down, the volume that's synchronously replicated to the other |
| | failure domain can be brought up to resume business with no data loss. One |
| | disadvantage of this model is that to make the control plane highly-available, the |
| | customer will have to deploy the control plane across at least three failure domains. |

The disclosure herein neither requires replication in the application layer nor requires a single highly available control plane across multiple failure domains.

### Single Pane UI

Setting up and managing a high availability application using a single pane of glass is desirable for it can make management easy, less time consuming, and less error prone. As such, it is appropriate to explore opportunities for setting up, monitoring, and performing actions (e.g., migrate, failover, failback) from a single control plane such as those provided by a multi-cluster management orchestrator (e.g., NKP, Openshift ACM or Kubernetes Federation) as shown in Table 2.

TABLE 2
Further features and support for high availability applications

| Feature # | Feature |
|---|---|
| 1 | Automated witness-orchestrated unplanned failover of the application. As such, in some |
| | embodiments, a recovery time objective (RTO) is undefined. However, events are raised for |
| | consumption by standard K8s ecosystem tools to bring awareness of the failure of the |
| | primary/active site. |
| 2 | Full support for failback either after a planned migration or an unplanned failover to the |
| | standby site. Steps to perform failback will have to be done manually. |
| 3 | Containerized environment to provide hooks to integrate with continuous deployment (CD) |
| | tools even though features such as sync config in tools like ArgoCD and other CD products |
| | and operators can interfere with some of the workflows provided for the high availability |
| | (HA) Application (such as migrate and failover). |
| 4 | Configuration replication will be near-real time, generally synchronously, but can be |
| | asynchronous in some situations. |
| 5 | Provide support for applications that use RWX volumes (i.e., file shares such as NFSv3/ |
| | NFSv4 shares). |
| 6 | Provide Support for ReadWriteOnce (RWO) volumes. |
| | Provide support for applications that use block volumes (e.g., PVCs of type RWO or |
| | RWOP). |
| 7 | File servers running on bare metal ESX can be synchronously replicated to another ESX |
| | cluster. A similar feature for provisioned AHV may be included in other embodiments. |
| 8 | Support for (1) “Nutanix Kubernetes Platform” (NKP), (2) “OpenShift” (OCP), (3) “Amazon |
| | EKS”, and (4) “Amazon EKS-Anywhere” clusters. |

### TERMINOLOGY

Purely for ease of understanding and not to be limiting, selected terms are presented in Table 3.

TABLE 3
Terminology

| Term | Description |
|---|---|
| SyncRep | A portmanteau of “synchronous” and “replication”, where replication of data occurs in a |
| | synchronous manner so that at any give moment there minimal difference between |
| | subject sites. |
| Stretch | If a resource is being handled in accordance with SyncRep, that resource is said to be in |
| | a stretch relationship. The terminology comes from the fact that the particular resource |
| | (in a containerized environment's case VG) is stretched across the two K8s clusters by |
| | virtue of SyncRep. |
| Break | If the SyncRep relationship between the two resources that are in stretch is broken, this |
| | is referred to as a ‘break’. |
| Primary site | The site where the user primarily intends to run their application in a steady state, which |
| | is also the preferred site for the user. By way of example, consider the following scenario: |
| | If the workload migrates to some other site or needs to be brought up at some remote |
| | site, this site will still be referred to as the primary site. |
| Secondary | The site where the synchronous replicated data is received in a steady state. As such, |
| site | the secondary site can run the application in case there is a loss of functionality with the |
| | primary site or if the primary site enters an alternative operational state (e.g., |
| | maintenance mode). |
| Active site | The site where the application is running. If the application moves, the site where the |
| | application has moved will be referred to as the active site. |
| Standby site | The site (either primary or secondary) that is not hosting the application. |

### Containerized Environment Application

A containerized environment application is a construct that can be described as a unit of data management provided by a containerized environment for the purpose of application of data management policies. It is a construct that creates a coarse logical knapsack around a group of Kubernetes building blocks (e.g., Deployment, StatefulSet, etc.) and the other supporting resources.

A containerized environment application specifies, through association, the Kubernetes building blocks of interest by allowing clients to identify the resources using selectors (e.g., label type, resource type). For instance, a building monitoring application running in a namespace within a Kubernetes cluster can have a deployment (e.g., a Nginx application, a StatefulSet managing a database, and a caching system such as Redis). A containerized environment application for building monitoring can be set up to include the desired resource types from across those K8s building blocks and data management policies, which can then be applied for the qualifying resource instances.

As such, a containerized environment application can be referred to as the entity, thus allowing for entity-centric management. However, unlike a virtual machine (VM) or a volume group (VG), the entity constitutes a loose grouping, and the containerized environment application construct lacks lifecycle management for the resources that evaluate to true for the predicates specified in the application selectors.

However, despite the fact that a containerized environment application cannot fully control the lifecycle of the underlying resources, a containerized environment application provides an abstraction to hang some of the primitives that are required to implement functions that help in high availability (HA) workflows; specifically, planned and unplanned failover.

For example, a planned failover involves bringing down the application on one K8s cluster and bringing up the same application on the standby K8s cluster. Bringing down the application ensures that access to volumes backed by unshared volume groups are completely and correctly torn down before the synchronously replicated unshared volume groups are green-listed for access from the standby K8s cluster; thus ensuring data integrity.

To enable the aforementioned functions, a containerized environment application is configured to support ‘stopping’ and ‘starting’ operations. The meanings of these operations are explained in Table 4.

TABLE 4
Explanation of Start and Stop operations

| Term | Semantic | |
|---|---|---|
| Stop | Stop watching for changes to the application programming interface (API) resources, collect | |
| | and store the application configurations in a well-defined location, stop the runtime | |
| | components and delete the resources from the K8s API server. | |
| Start | 1. | use_existing_config = false: Collect and store the initial configuration, start watching the |
| | | API server and keep the configuration and the well-known location up-to-date. |
| | 2. | use_existing_config = true: Apply the earlier collected configuration in the namespace and |
| | | start watching for new updates. Update the config stored in the well-defined location with |
| | | changes from watching the API server. |

### Custom Resource Definitions

To enable clients to communicate the desired state of the application, the containerized environment application may be augmented (possibly using a custom resource definition (CRD)) to support customer-specific features.

In some embodiments, the behavior of the containerized environment may be governed by defined state transitions between configuration and runtime conditions. Certain transitions are designated as valid, while others are restricted or blocked. Invalid transitions can be blocked, for example using webhooks. In addition, once a containerized environment application has been started with a stored configuration, the containerized environment might be configured to prevent reapplication of the same configuration on the cluster during reconciliation. Further, the application of the existing configuration on the cluster is made to appear idempotent using, for example, a marker annotation on application (custom resource) CR.

### Valid and Invalid State Transitions

In some embodiments, the application lifecycle can be represented as a state machine governed by configuration and runtime parameters (e.g., useExistingConfig, started, etc.). State transitions govern how the system restores configuration, starts or stops monitoring, and performs cleanup or failover operations, ensuring consistent operation without data loss.

### Procedure for Stopping the Runtime Components of a Containerized Environment Application

Various techniques can be used to allow the Kubernetes building blocks to relinquish access to critical resources (e.g., volume groups). Described below in Table 5 are several techniques that support critical resource access verbs.

TABLE 5
Various techniques to allow the Kubernetes building blocks to relinquish access to resources

| Technique | Description |
|---|---|
| Scaling down | Scaling down replica sets to zero enables re associated runtime components to be |
| replica sets to zero | removed. Scaling down replica sets to zero can enable starting up an application to |
| | be simplified, since the original replica count could be resourced. However, there |
| | are limitations with the scaling down replica sets to zero approach. Specifically, |
| | scale requests may not be honored if some replicas are unhealthy or if some |
| | applications specify a minimum number of replicas. As such, various problems |
| | may occur, for example application termination being permanently stuck. |
| Customized | As an example, instead of deciding on a single algorithm for bringing down an |
| Behavior | application, the behavior is customizable. As such, a containerized environment |
| | could read information on how it should handle stopping an application from a |
| | resource. |
| Deletion of Control | Delete the control structure/owner resources that are identified by a containerized |
| Structure/Owner | environment application, based on the specific field of the containerized |
| Resources | environment application custom resource. Deleting the controller structures may |
| | result in deletion of their owned resources in a bottom-up deletion manner. |
| | Resources that do not have an owner reference set shall be explicitly deleted. |

Building upon the legacy approaches described herein, the technique of the disclosure illustrates a novel approach. The root resource of the ‘owned’ resources will be identified and marked for deletion, in this embodiment this will be completed by an application controller.

### Handling Stateful Components of an Application During Termination

A PersistentVolumeChain (PVC) is a fundamental unit of persistent storage in Kubernetes. Storage can be claimed, for example, by a pod which is the smallest runtime unit in Kubernetes, via a PVC. Once claimed, the PVC cannot be bound to another pod until it is released by the pod, or the pod gets deleted. However, deletion of a PVC while it is claimed by an active pod is not executed until the pod is deleted. The PVC goes into a ‘Terminating’ state indicating that it is queued for garbage collection, but the finalizer on the PVC is only removed once the pod releases the claim either explicitly (via an update of its spec) or implicitly when it gets deleted (TODO: k8s doc link).

In a synchronous replication configuration of volume groups (VG), deleting a volume group in the primary or standby site results in the deletion of its counterpart (e.g., PVC). As such careful consideration should be made when deleting a PVC that is referring to a VG participating in a synchronous replication relationship to avoid deletion of the VG. For example, a PV that is bound to the PVC is not deleted when the PVC is marked for deletion. Further, for PVs with a reclaim policy set to ‘retain’, deleting the PV does not result in deleting the underlying infrastructure storage unit. As a result, deletion of the PV without affecting the volumes and their sync relationship can be accomplished by the application controller as part of the termination workflow.

As described herein, one embodiment of the workloads and operations to be performed when working with a containerized environment is described below. By way of further illustration, Syncrep might be exposed as an agent or an agent may perform one or more of the operations given in Table 6.

TABLE 6
Possible operations performed by Syncrep or Agent

| Step | Operation |
|---|---|
| 1 | Setup |
| 2 | Seeding state - waiting for volumes to be synced |
| 3 | Steady state application sync (in a near-synchronous manner) |
| 4 | Health Monitoring (volume and app health) |
| 5 | Update the application definition |
| 6 | Break/Pause stretch - making primary site independent (in case the secondary site goes down) |
| 7 | Failover (secondary is up) |
| | a. planned maintenance active on primary: move workload from primary to secondary |
| | b. in case of disaster: bring up application on secondary |
| 8 | Failback (not for first release of a containerized environment SyncRep) |
| | a. Resuming bidirectional sync from target to secondary to primary |
| 9 | Async support for VGs in SyncRep |
| | a. Async snapshots taken for VGs that are in Syncrep won't be crash |
| 10 | Delete of SyncRep ProtectionPlan |

The following sections cover the above-mentioned workflows/operations in more detail.

### Conditions

The status of the SyncRep resource will be represented, in this embodiment, through the use of conditions to communicate what the containerized environment SyncRep controller is doing at a given point in time.

In some embodiments, status information may be represented using Kubernetes conditions or an equivalent construct to report operational states, progress, or error messages within a cluster. Conditions may be used for both observability and decision-making purposes, providing a standardized way to communicate the status of managed resources.

The use of the aforementioned conditions enables the system to determine transitions, handle failover cases, or trigger specific remediation workflows as appropriate, without requiring explicit user intervention. Conditions may have multiple fields. With respect to the present embodiment, a selection of conditions of interest are given in Table 7.

TABLE 7
Conditions of interest

| Type | Progressing (type or name of the condition) |
|---|---|
| Status | True/False/Unknown (supported values) |
| Reason | <Programmatic identifier - why the condition is True/False> |
| Message | <human readable string> |

Keeping track of the SyncRep controller's state machine can be done by conditions. Additionally, conditions will also be used to provide an accurate picture to any external clients as to what is the then-current state of the system. Condition fields (e.g., Type, Status, etc.) can be considered as an API response that external clients can rely on.

### Setup and Steady State

The present section discloses one method for setting up SyncRep in the k8s cluster and what it means to continue SyncRep. Setting up a containerized environment SyncRep involves setting up synchronous replication for two things: data (0 RPO) and config (near 0 RPO). Setting up for sync replication of data involves setting up the disaster recovery (DR) protection policy on the prism central (PC). A containerized environment will communicate to the cluster controller to create a zero RPO protection policy. The protection policy should be created with a category that will also be attached to all the VGs that come under the ambit of the SyncRep. As such, this would help to make sure that the VGs are synchronously replicated.

In some embodiments, synchronization between primary and standby environments may involve a witness orchestrator that coordinates configuration and storage replication across clusters to maintain a near-zero recover point objective (RPO).

### Update of the Application

Updating the Application should entail figuring out what has changed and then syncing the config and, if applicable, syncing the relevant backing VG.

Unlike in VGs, where the protection policy is set up in the cluster controller for the VG to be replicated, application config sync is something a containerized environment has to directly handle. It can handle that in two ways. The first is to periodically scan the expanse of ‘Application’ and see if there is any change and sync it. The second is to perform the sync based on a watch notification.

The first option may be easier to implement of the two. However, it involves doing the collection on a periodic basis. Since this is a config change, the collection maybe unchanged. Additionally, the configs may be out of sync for the duration of the periodic interval in the worst case. As such, the second option may be advantageous, which entails a watch notification so that the collection is done when needed and a near-zero RPO sync can be provided for config.

In certain embodiments, there may be a duration (e.g., between t1 and t2) when a containerized environment is unaware about a newly-provisioned volume for which synchronous replication is expected to have been set up by time t1. This duration of unawareness in a containerized environment is the result of CSI provisioning storage and a containerized environment later getting to know about the newly created volume and then initiating the steps for setting up synchronous replication of volumes.

### Break & Resume

In some embodiments, proper use of SyncRep may involve, both primary and secondary actively running. In the event of the secondary either not being reachable OR being down would mean that the writes cannot be forwarded to the secondary. As such, writes done by the client to the VGs may fail.

One technique to facilitate forward progress from the application point of view would be to break the stretch and become independent. This would happen via the Break functionality. Break is something that the VG SyncRep feature already provides via the use of a Recovery Plan. A Recovery Plan, when configured with witness, provides the capability to do auto break upon realization that the secondary is not reachable for a finite amount of time. This allows the application to make forward progress without needing any user intervention. The config replication can take a cue from the storage replication and stop the sync of configs as soon as it discovers that the storage has become independent.

From the storage perspective there is a need for a way to resume SyncRep automatically once the secondary comes back up again. A containerized environment can provide a way to resume from this auto break by invoking cluster controller APIs to resume sync on the entities that are in a break state once it is known that the remote k8s is reachable. Failover

TABLE 8
Two types of failover

| Acronym | Type |
|---|---|
| PFO | Planned Failover |
| UPFO | Unplanned Failover |

PFO is an operation that is carried out when the system is in a healthy state and a certain maintenance activity on the primary cluster involves the application workloads to be migrated to a different (secondary) cluster. This involves moving the storage entities along with the Kubernetes application configs from the primary cluster to the secondary cluster.

UPFO, on the other hand, is an operation that is carried out to maintain business continuity in the event of a disaster on the primary site. UPFO helps ensure that the user's sync-protected application(s) are brought up in a secondary site without incurring any data loss and minimizing application downtime.

In some embodiments, CRs are provided that distinctly accept the user intent to failover the application in a ‘planned’ or an ‘unplanned’ manner. Both of these operations will be executed in specific scenarios that are deemed acceptable for performing failover operations (e.g., a planned failover operation will commence when the 2 HA applications are in a healthy sync relationship with each other.

Failover requests can be submitted on the site where the application is intended to be brought up.

### Planned Failover Workflow

TABLE 9
Sequence of operations that are performed during
planned failover to facilitate data reliability

| Step | |
|---|---|
| # | Operation |
| 1 | Planned failover CR applied on the secondary site. |
| 2 | The application and high availability (HA) application on |
| | the primary site are modified to go into a standby/off state. |
| 3 | The K8s resources on the primary site are terminated (deleted) |
| | to ensure no runtime entities are accessing the volumes. |
| 4 | The high availability (HA) application on the secondary site |
| | promotes the VGs on the secondary site to become active. |
| 5 | The K8s resources are started on the secondary site and start |
| | accessing the VGs via the PVCs. |

TABLE 10
Planned failover progress indicators

| Step # | Indicator |
|---|---|
| 1 | The Failover CR's status sub resource will be the primary entity to reflect the status of the |
| | failover workflow. |
| 2 | The Application CR on the primary and secondary sites will reflect their status independently. |
| 3 | The HA App CR on the secondary cluster will eventually reflect a healthy state (e.g., |
| | Serving = true, Synchronized = true, Independent = false). |

Steady State after Planned Failover

After the completion of a planned failover operation, the secondary site automatically sets up a reverse synchronization workflow with the primary cluster. This helps to ensure that a containerized environment continues to synchronize the volume data and config data across the two clusters that are part of the sync replication relationship.

As such, a containerized environment may expect that the user has configured a remote and replication target on the secondary cluster that points to the same cluster and namespace as the primary site. In some embodiments, this is deemed to be a prerequisite for sync rep.

The failover evaluation logic may consider the serving, synchronization, and independence states collectively to determine whether a failover request is valid or must be denied.

### Failback

Failback is similar to failover. However, one distinction can be made is that in case of failback it is possible that there might be resources still operational on the primary site. This is because in case of a disaster event it is possible that instead of the k8s cluster getting completely wiped out, it just was down and later came back up. In such a scenario, before doing the failback, a verification may be performed to confirm that no resources are present on the primary. From the storage side, once verification is confirmed this indicates that the VGs are cleaned up and new ones are created again if there is such a scenario. From the application side, handling may be introduced if this is to be done automatically.

Async Support with SyncRep

To protect against a wider region failure, some customers may want to protect their workloads by having an asynchronous replication setup to a third site. The way a containerized environment does snapshotting is by calling the API with all the VGs to be snapshotted in one go. The cluster controller takes this to mean that the VGs need to be consistent.

### Heartbeat Between the Two K8s Clusters

An active site periodically does a heartbeat with the standby to test if it is up or not. An active site also updates a field in the standby site. The standby site looks at when the resource was updated and based on that it can infer if it has the most up-to-date information or not.

Additionally, the case when the application has started on the remote site and it is also up locally should be handled. This can happen in the case of UPFO on the secondary site when the primary site is down but the primary site comes back up later.

### Managing the Lifecycle of Resources Using Owner References and Finalizers

TABLE 11
Example resource lifecycle management rules for custom resources

| Rule | |
|---|---|
| ID | Lifecycle Management Description |
| 1 | Custom resources will leverage metadata.ownerReferences |
| | to manage the lifecycle of the resources they create within |
| | a single K8s cluster. |
| 2 | For resources created outside the K8s cluster, such as in |
| | the peering K8s cluster or in cluster controller or elsewhere, |
| | CRs that create these outside resources have finalizers to help |
| | them garbage collect those resources. |
| 3 | Finalizers should be set on resources to block inadvertent |
| | deletion of resources that are not meant to be manually deleted |
| | in the regular use scenarios. |

### Failover Embodiment

In certain embodiments, failover operations may be represented using custom resources that distinguish between planned and unplanned failover events. For example, a resource (e.g., AppPlannedFailover) resource may indicate an intentional migration of an application state to a standby site, while another resource (e.g., AppUnplannedFailover) may be automatically generated in response to a detected failure or loss of connectivity. Each such resource may include metadata identifying the affected application, completion status, and operational conditions relevant to the failover process.

### Setup CRApproach #1

As described herein, there can be a separate independent CR that serves the purpose of setting up SyncRep. In some implementations, legacy configurations for protection and scheduling may involve multiple resource types or controllers. The disclosed embodiment may simplify such configurations by providing a unified framework capable of managing both synchronous and asynchronous protection modes.

In certain embodiments, synchronization protection for an application may be defined using a declarative specification that identifies the application, replication target, synchronization interval, and operational status. Such a specification allows the system to automatically coordinate synchronization behavior across clusters without requiring manual intervention.

### Setup CR Approach #2

In this embodiment, a containerized environment reuses the existing CR of Protection Plan, Job Scheduler and App Protection Plan. SyncRep's intention is provided to a containerized environment by creating a JobScheduler with an interval in minutes value of 0. The benefit of this approach is that it reuses existing CRs and the Sync+Async support is captured with existing conventions itself.

In some embodiments, the system may leverage existing Kubernetes custom resources (CRs) to configure synchronization or replication behavior. This approach allows the containerized environment to express synchronization intent using existing declarative conventions, avoiding the need to define entirely new resource types.

### Setup CR Approach #3

Having a JobScheduler with a value of 0 may not be practical from a JobScheduler resource perspective. However, it may be practical to have the notion of Syncrep captured in the ProtectionPlan CR itself. Though the current CR has no differentiating fields that would allow for a SyncRep vs. Async differentiation, new field(s) will have to be introduced to specify SyncRep. Care would have to be taken to ensure that the new fields and some existing fields are mutually exclusive (e.g., specifying scheduleName and syncProtection together should result in an error).

In certain embodiments, protection configurations may be defined through an extended protection plan resource that incorporates fields for both synchronous and asynchronous replication modes. The protection plan may include parameters (e.g., replication target, synchronization interval, and retention policy, control flags, etc.) to enable or suspend protection operations. These enhancements allow the system to differentiate between synchronous replication and asynchronous replication within a unified declarative specification. In some implementations, additional validation logic may ensure that mutually exclusive parameters are not specified together, thereby maintaining consistency and preventing configuration conflicts.

### Failover CR

In some embodiments, migration and failover operations may be implemented using distinct custom resources that represent different operational intents. For example, an AppMigration resource may define parameters and conditions associated with planned movement of an application or its configuration to another target environment, whereas an AppFailover resource may capture the conditions and completion state associated with an unplanned recovery or automatic restart scenario. Each resource may include fields identifying the application, target environment, operational status, and completion indicators, thereby enabling the controller to execute context-specific orchestration workflows for either a planned migration or failover recovery.

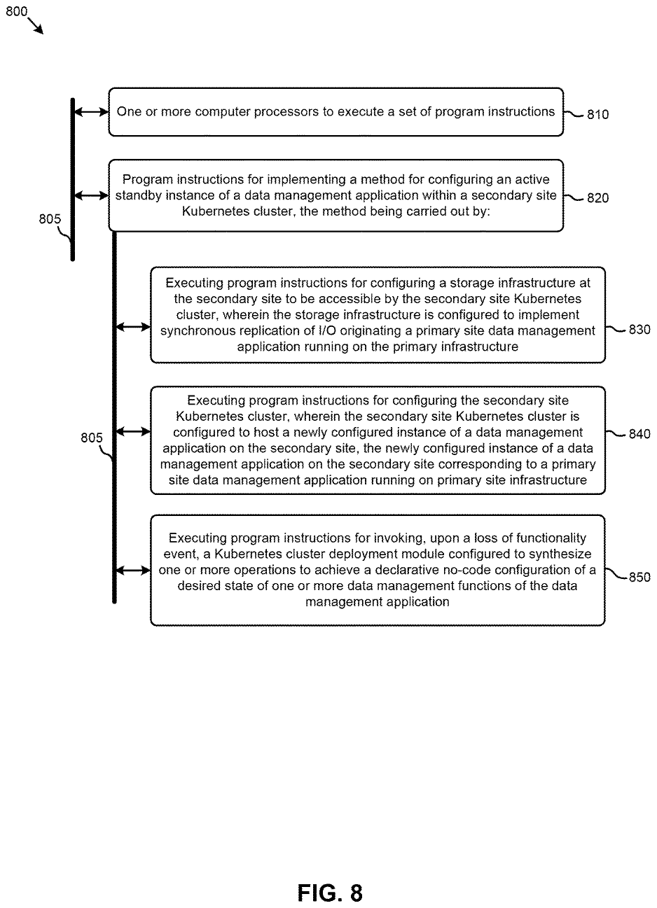

FIG. 8 depicts system components as arrangements of computing modules that are interconnected so as to implement certain of the herein-disclosed embodiments. The arrangement 800 includes a computer processor that accesses a computer readable medium having stored thereon a sequence of instructions which, when stored in memory and executed by the processor cause the processor to perform the acts of the sequence of instructions” (module 810 and module 820). In this case the sequence of instructions involves: configuring a storage infrastructure at the secondary site to be accessible by the secondary site Kubernetes cluster, wherein the storage infrastructure is configured to implement synchronous replication of I/O originating a primary site data management application running on the primary infrastructure (module 830); configuring the secondary site Kubernetes cluster, wherein the secondary site Kubernetes cluster is configured to host a newly configured instance of a data management application on the secondary site, the newly configured instance of a data management application on the secondary site corresponding to a primary site data management application running on primary site infrastructure (module 840); and invoking (e.g., upon a loss of functionality event), a Kubernetes cluster deployment module configured to synthesize one or more operations to achieve a declarative no-code configuration of a desired state of one or more data management functions of the data management application (module 850). Any module can communicate with any other module over bus or network segments 805.

### System Architecture Overview

### Additional System Architecture Examples

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to the following figures.

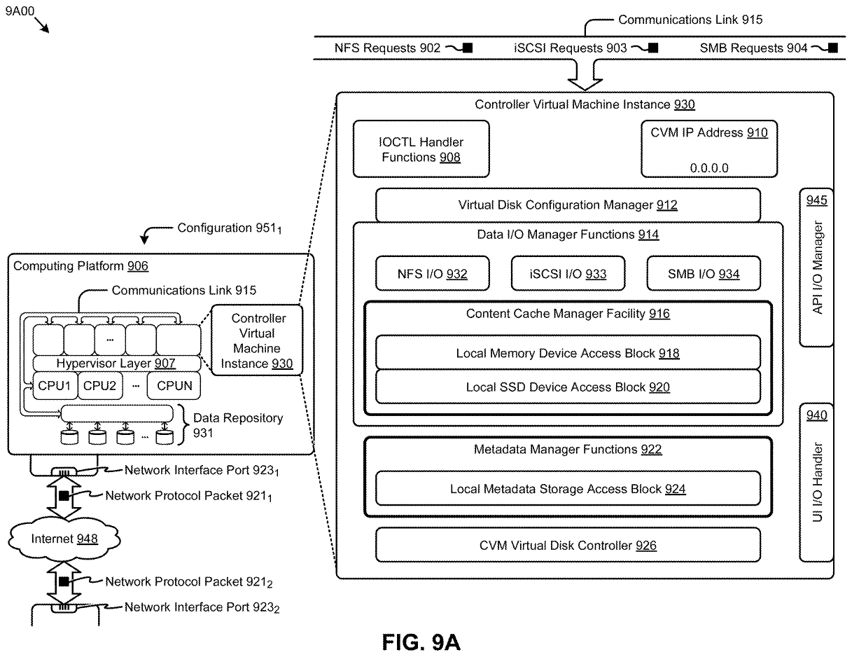

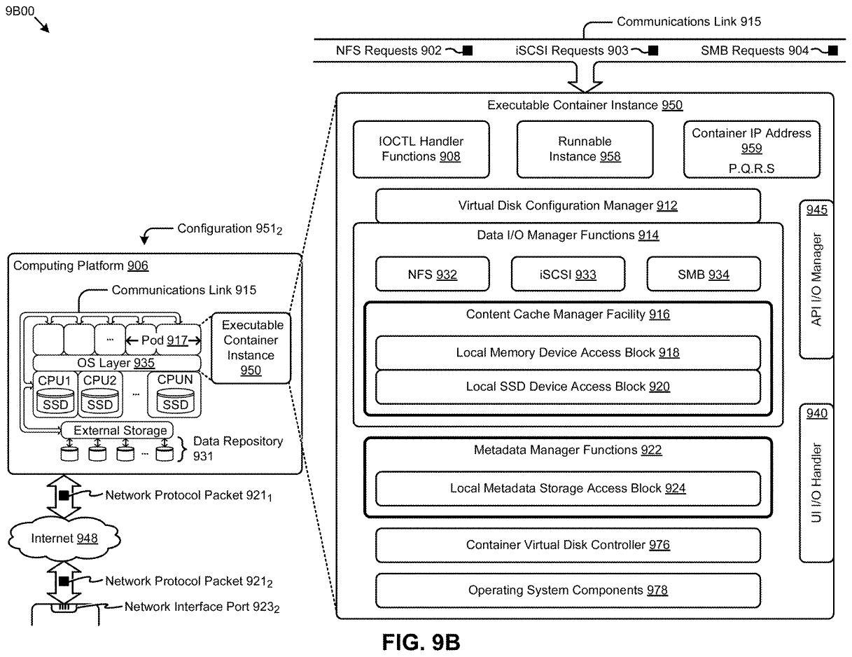

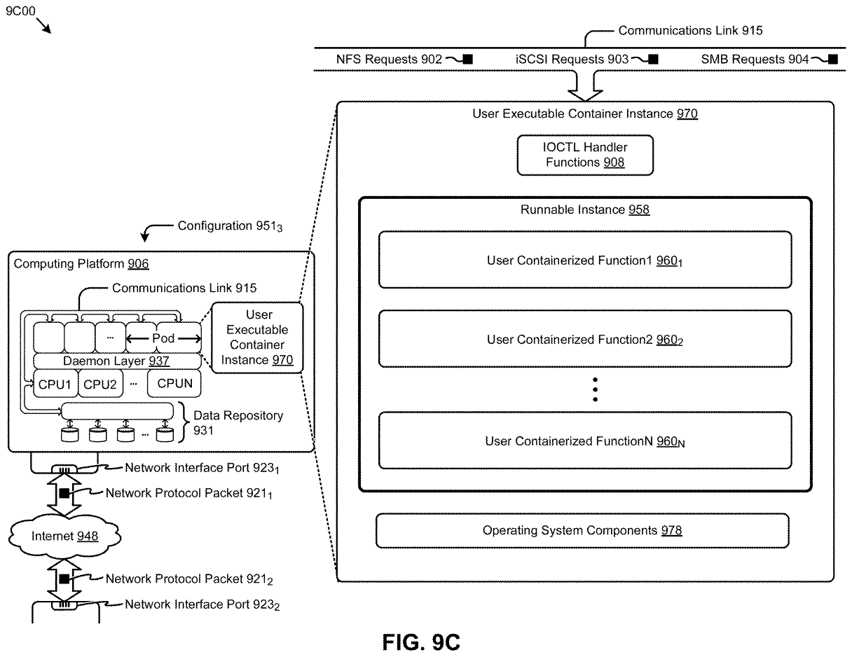

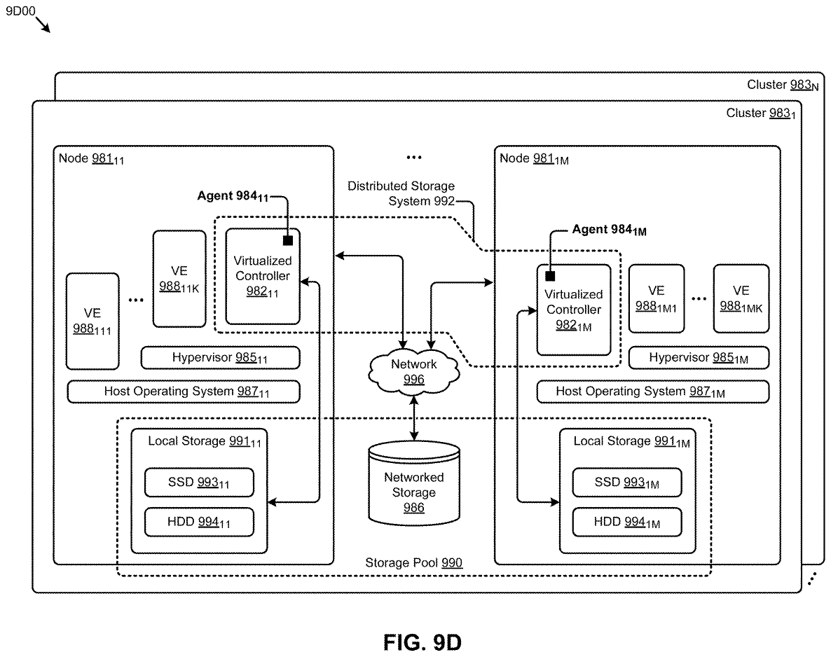

FIG. 9A depicts a virtualized controller as implemented in the shown virtual machine architecture 9A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as hypervisor layer 907). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, computing and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers and/or as other types of virtualized entities. In some systems and/or environments, hypervisor-assisted virtualization techniques and operating system (OS) virtualization techniques are combined.

As shown, virtual machine architecture 9A00 comprises a collection of interconnected components suitable for implementing embodiments of the present disclosure and/or for use in the herein-described environments. Moreover, virtual machine architecture 9A00 includes a controller virtual machine instance 930 in configuration 951₁ that is further described below as pertaining to implementation of such a controller virtual machine instance 930. Configuration 951₁ supports virtual machine instances that are deployed as user virtual machines, or controller virtual machines or both. Such virtual machines interface with a hypervisor layer (as shown). Some virtual machines are configured to process storage inputs or outputs (I/O or IO) as received from any or every source within the computing platform. An example implementation of such a virtual machine that processes storage I/O is depicted as 930.

In this and other configurations, a controller virtual machine instance receives block I/O storage requests as network file system (NFS) requests in the form of NFS requests 902, and/or internet small computer system interface (iSCSI) block IO requests in the form of iSCSI requests 903, and/or Samba file system (SMB) requests in the form of SMB requests 904. The controller virtual machine (CVM) instance publishes and responds to an internet protocol (IP) address (e.g., CVM IP address 910). Various forms of input and output can be handled by one or more IO control (IOCTL) handler functions (e.g., IOCTL handler functions 908) that interface to other functions such as data IO manager functions 914 and/or metadata manager functions 922. As shown, the data IO manager functions can include communication with virtual disk configuration manager 912 and/or can include direct or indirect communication with any of various block IO functions (e.g., NFS 932, iSCSI 933, SMB 934, etc.).

In addition to block IO functions, this configuration supports input or output (IO) of any form (e.g., block IO, streaming IO) and/or packet-based IO such as hypertext transport protocol (HTTP) traffic, etc., through either or both of a user interface (UI) handler such as UI IO handler 940 and/or through any of a range of application programming interfaces (APIs), possibly through API IO manager 945.

Communications link 915 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, the detail of controller virtual machine instance 930 includes content cache manager facility 916 that accesses storage locations, possibly including local dynamic random access memory (DRAM) (e.g., through local memory device access block 918) and/or possibly including accesses to local solid state storage (e.g., through local SSD device access block 920).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 931, which in turn can be formatted into any one or more storage areas, and which can comprise parameterized storage accessible by a key (e.g., a filename, a table name, a block address, an offset address, etc.). Data repository 931 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 924. The data repository 931 can be configured using CVM virtual disk controller 926, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . CPUN). According to certain embodiments of the disclosure, two or more instances of configuration 951₁ can be coupled by communications link 915 (e.g., backplane, local area network, public switched telephone network, wired or wireless network, etc.) and each instance may perform respective portions of sequences of instructions as may be required to practice embodiments of the disclosure.

The shown computing platform 906 is interconnected to the Internet 948 through one or more network interface ports (e.g., network interface port 923₁ and network interface port 923₂). Configuration 951₁ can be addressed through one or more network interface ports using an IP address. Any operational element within computing platform 906 can perform sending and receiving operations using any of a range of network protocols, possibly including network protocols that send and receive packets (e.g., network protocol packet 921₁ and network protocol packet 9212).

Computing platform 906 may transmit and receive messages that can be composed of configuration data and/or any other forms of data and/or instructions organized into a data structure (e.g., communications packets). In some cases, the data structure includes program instructions (e.g., application code) communicated through the Internet 948 and/or through any one or more instances of communications link 915. Received program instructions may be processed and/or executed by a CPU as it is received and/or program instructions may be stored in any volatile or non-volatile storage for later execution. Program instructions can be transmitted via an upload (e.g., an upload from an access device over the Internet 948 to computing platform 906). Further, program instructions and/or the results of executing program instructions can be delivered to a particular user via a download (e.g., a download from computing platform 906 over the Internet 948 to an access device).

Configuration 951₁ is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to implementing and maintaining an active standby data management applications in Kubernetes. In some embodiments, a module may include one or more state machines and/or combinational logic used to implement or facilitate the operational and/or performance characteristics pertaining to implementing and maintaining an active standby data management applications in Kubernetes.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of implementing and maintaining an active standby data management applications in Kubernetes). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to implementing and maintaining an active standby data management applications in Kubernetes, and/or for improving the way data is manipulated when performing computerized operations pertaining to orchestrating interactions of containerized data management application so as to facilitates establishment and maintenance of an active regime between two of more Kubernetes clusters.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 9B depicts a virtualized controller implemented by containerized architecture 9B00. The containerized architecture comprises a collection of interconnected components suitable for implementing embodiments of the present disclosure and/or for use in the herein-described environments. Moreover, the shown containerized architecture 9B00 includes an executable container instance 950 in configuration 951₂ that is further described below as pertaining to executable container instance 950. Configuration 951₂ includes an operating system layer (the shown OS layer 935) that performs addressing functions such as providing access to external requestors (e.g., user virtual machines or other processes) via an IP address 959 (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

An operating system layer (e.g., the shown OS layer 935) can perform port forwarding to any executable container (e.g., executable container instance 950). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a corresponding virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls”, “dir”, etc.). The executable container might optionally include operating system components 978, however such a separate set of operating system components need not be provided. As an alternative, an executable container can include runnable instance 958, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 976. Such a container virtual disk controller can perform any of the functions that the aforementioned CVM virtual disk controller 926 can perform, yet such a container virtual disk controller does not rely on a hypervisor or any particular host operating system so as to perform its range of functions.

In some environments, multiple executable containers can be collocated and/or can share one or more contexts. For example, multiple executable containers that share access to a virtual disk can be assembled into a pod 917 (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod). In various implementations a pod represents a set of running or runnable processes. A pod can be deployed as the lowest level executable unit of a containerized application. As used herein, a pod that is instanced within a node can be addressed by a local IP address.

FIG. 9C depicts a virtualized controller implemented by a daemon-assisted containerized architecture 9C00. The containerized architecture comprises a collection of interconnected components suitable for implementing embodiments of the present disclosure and/or for use in the herein-described environments. Moreover, the shown daemon-assisted containerized architecture includes a user executable container instance 970 in configuration 951₃ that is further described below as pertaining to user executable container instance 970. Configuration 951₃ includes a daemon layer 937 that performs certain functions of an operating system.

User executable container instance 970 comprises any number of user containerized functions (e.g., user containerized function 1960₁, user containerized function2 960₂, . . . , user containerized functionN 960_{N}). Such user containerized functions can execute autonomously or can be interfaced with or wrapped in a runnable object to create a runnable instance (e.g., runnable instance 958). In some cases, the shown operating system components 978 comprise portions of an operating system, which portions are interfaced with or included in the runnable instance and/or any user containerized functions. In this embodiment of a daemon-assisted containerized architecture, the computing platform 906 might or might not host operating system components other than operating system components 978. More specifically, the shown daemon might or might not host operating system components other than operating system components 978 of user executable container instance 970.

The virtual machine architecture 9A00 of FIG. 9A and/or the containerized architecture 9B00 of FIG. 9B and/or the daemon-assisted containerized architecture 9C00 of FIG. 9C can be used in any combination to implement a distributed platform that contains multiple servers and/or nodes that manage multiple tiers of storage where the tiers of storage might be formed using the shown data repository 931 and/or any forms of network accessible storage. As such, the multiple tiers of storage may include storage that is accessible over communications link 915. Such network accessible storage may include cloud storage or networked storage (NAS) and/or may include all or portions of a storage area network (SAN). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are organized (e.g., concatenated) to form a storage pool having an address space that is formed of a plurality of non-overlapping address range segments, (possibly contiguous non-overlapping address range segments segments), respective ones of which non-overlapping address range segments correspond to (1) addresses corresponding to node-internal storage devices, or (2) addresses corresponding to any forms of network-accessible storage (e.g., network-attached storage (NAS), or a storage area network (SAN), or any form of cloud-provided storage).

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor or corresponding computer modules that manages the interactions between the underlying hardware and user virtual machines or containers that run client software.

Distinct from user virtual machines or user executable containers, a special controller virtual machine or a special controller executable container can be used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines-above the hypervisors thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 9D depicts a distributed virtualization system in a multi-cluster environment 9D00. The shown distributed virtualization system is configured to be used to implement the herein disclosed techniques. Specifically, the distributed virtualization system of FIG. 9D comprises multiple clusters (e.g., cluster 983₁, . . . , cluster 983_{N}) comprising multiple nodes that have multiple tiers of storage in a storage pool. Representative nodes (e.g., node 981₁₁, . . . , node 981_{1M}) and storage pool 990 associated with cluster 983₁ are shown. Each node can be associated with one server, multiple servers, or portions of a server. The nodes can be associated (e.g., logically and/or physically) with the clusters. As shown, the multiple tiers of storage include storage that is accessible through a network 996, such as a networked storage 986 (e.g., a storage area network or SAN, network attached storage or NAS, etc.). The multiple tiers of storage further include instances of local storage (e.g., local storage 991₁₁, . . . , local storage 991_{1M}). For example, the local storage can be within or directly attached to a server and/or appliance associated with the nodes. Such local storage can include solid state drives (SSD 993₁₁, . . . , SSD 993_{1M}), hard disk drives (HDD 994₁₁, . . . , HDD 994_{1M}), and/or other storage devices.

As shown, any of the nodes of the distributed virtualization system can implement one or more user virtualized entities (VEs) such as the virtual entity (VE) instances shown as VE 988₁₁₁, . . . , VE 988_{11K}, . . . , VE 988_{1M1}, . . . , VE 988_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 987₁₁, . . . , host operating system 987_{1M}), while the VMs run multiple applications on various respective guest operating systems. Such flexibility can be facilitated at least in part by a hypervisor (e.g., hypervisor instance 985₁₁, . . . , hypervisor instance 985_{1M}), which hypervisor instances are logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 987₁₁, . . . , host operating system 987_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 990 by the VMs and/or the executable containers.

Multiple instances of such virtualized controllers can coordinate within a cluster to form the distributed storage system 992 which can, among other operations, manage the storage pool 990. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 981₁₁ can interface with a controller virtual machine (e.g., virtualized controller 982₁₁) through hypervisor instance 985₁₁ to access data of storage pool 990. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 992. For example, a hypervisor at one node in the distributed storage system 992 might correspond to software from a first vendor, and a hypervisor at another node in the distributed storage system 992 might correspond to a second software vendor. As another virtualized controller implementation example, executable containers can be used to implement a virtualized controller (e.g., virtualized controller 982_{1M}) in an operating system virtualization environment at a given node. In this case, for example, the virtualized entities at node 981_{IM} can access the storage pool 990 by interfacing with a controller container (e.g., virtualized controller 982_{1M}) through hypervisor instance 985_{1M} and/or the kernel of host operating system 987_{1M}.

In certain embodiments, one or more instances of an agent can be implemented in the distributed storage system 992 to facilitate the herein disclosed techniques. Specifically, agent 984₁₁ can be implemented in the virtualized controller 982₁₁, and agent 984_{1M} can be implemented in the virtualized controller 982_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to orchestrating interactions of containerized data management application so as to facilitates establishment and maintenance of an active regime between two of more Kubernetes clusters can be brought to bear through implementation of any one or more of the foregoing techniques. Moreover, any aspect or aspects of Kubernetes by itself fails to offer sufficient built-in facilities to aid in high-availability deployments can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts for configuring a data management application within a secondary site Kubernetes cluster residing at a secondary site, the acts comprising:
configuring a storage infrastructure at the secondary site to be accessible by the secondary site Kubernetes cluster, wherein the storage infrastructure is configured to implement synchronous replication of/O originating from a Kubernetes cluster residing at a primary site;
configuring the secondary site Kubernetes cluster, wherein the secondary site Kubernetes cluster is configured to host a newly configured instance of a primary site data management application on the secondary site; and
invoking a Kubernetes cluster deployment module configured to synthesize one or more operations to achieve a declarative no-code configuration of a desired state of one or more data management functions of the primary site data management application.

2. The non-transitory computer readable medium of claim 1, further comprising instructions which, when stored in memory and executed by the processor cause the processor to perform further acts of:
invoking an ongoing management module that monitors at least some aspects of the secondary site Kubernetes cluster so that the desired state of the one or more data management functions of the primary site data management application is maintained under changing conditions.

3. The non-transitory computer readable medium of claim 1, wherein the Kubernetes cluster residing at the secondary site is sized to facilitate powering-up one or more virtualized entities in the secondary site, wherein the virtualized entities in the secondary site are clones of corresponding ones of the virtualized entities in the primary site.

4. The non-transitory computer readable medium of claim 1, wherein the primary site data management application running on primary site infrastructure implements both of, a virtualization system that supports user virtualized entities, and a set of one or more executable containers that constitute a containerized data management application.

5. The non-transitory computer readable medium of claim 4, wherein the containerized data management application provides at least one of, a crash-consistent snapshot facility, or a recovery point optimization facility.

6. The non-transitory computer readable medium of claim 1, further comprising instructions which, when stored in memory and executed by the processor cause the processor to perform further acts of:
initiating, responsive to a loss of functionality event, automated bring-up of the data management application onto the secondary site.

7. The non-transitory computer readable medium of claim 6 wherein the loss of functionality event is a simulated failover event that initiates simulated orchestration and timing sequences.

8. The non-transitory computer readable medium of claim 1 further comprising instructions which, when stored in memory and executed by the processor cause the processor to perform further acts of:
mapping the declarative no-code configuration into computer-implementable operations;
executing at least some of the computer-implementable operations; and
carrying out remediation cycles until the desired state of the one or more data management functions has been achieved at the secondary site.

9. A method for configuring a data management application within a secondary site Kubernetes cluster residing at a secondary site, the method comprising:
configuring a storage infrastructure at the secondary site to be accessible by the secondary site Kubernetes cluster, wherein the storage infrastructure is configured to implement synchronous replication of/O originating from a Kubernetes cluster residing at a primary site;
configuring the secondary site Kubernetes cluster, wherein the secondary site Kubernetes cluster is configured to host a newly configured instance of a primary site data management application on the secondary site; and
invoking a Kubernetes cluster deployment module configured to synthesize one or more operations to achieve a declarative no-code configuration of a desired state of one or more data management functions of the primary site data management application.

10. The method of claim 9, further comprising:
invoking an ongoing management module that monitors at least some aspects of the secondary site Kubernetes cluster so that the desired state of the one or more data management functions of the primary site data management application is maintained under changing conditions.

11. The method of claim 9, wherein the Kubernetes cluster residing at the secondary site is sized to facilitate powering-up one or more virtualized entities in the secondary site, wherein the virtualized entities in the secondary site are clones of corresponding ones of the virtualized entities in the primary site.

12. The method of claim 9, wherein the primary site data management application running on primary site infrastructure implements both of, a virtualization system that supports user virtualized entities, and a set of one or more executable containers that constitute a containerized data management application.

13. The method of claim 12, wherein the containerized data management application provides at least one of, a crash-consistent snapshot facility, or a recovery point optimization facility.

14. The method of claim 9, further comprising:
initiating, responsive to a loss of functionality event, automated bring-up of the data management application onto the secondary site.

15. The method of claim 14 wherein the loss of functionality event is a simulated failover event that initiates simulated orchestration and timing sequences.

16. The method of claim 9 further comprising:
mapping the declarative no-code configuration into computer-implementable operations;
executing at least some of the computer-implementable operations; and
carrying out remediation cycles until the desired state of the one or more data management functions has been achieved at the secondary site.

17. A system for configuring a data management application within a secondary site Kubernetes cluster residing at a secondary site, the system comprising:
a storage medium having stored thereon a sequence of instructions; and
a processor that executes the sequence of instructions to cause the processor to perform acts comprising,
configuring a storage infrastructure at the secondary site to be accessible by the secondary site Kubernetes cluster, wherein the storage infrastructure is configured to implement synchronous replication of/O originating from a Kubernetes cluster residing at a primary site;
configuring the secondary site Kubernetes cluster, wherein the secondary site Kubernetes cluster is configured to host a newly configured instance of a primary site data management application on the secondary site; and
invoking a Kubernetes cluster deployment module configured to synthesize one or more operations to achieve a declarative no-code configuration of a desired state of one or more data management functions of the primary site data management application.

18. The system of claim 17, further comprising instructions which, when stored in memory and executed by the processor cause the processor to perform further acts of:
invoking an ongoing management module that monitors at least some aspects of the secondary site Kubernetes cluster so that the desired state of the one or more data management functions of the primary site data management application is maintained under changing conditions.

19. The system of claim 17, wherein the Kubernetes cluster residing at the secondary site is sized to facilitate powering-up one or more virtualized entities in the secondary site, wherein the virtualized entities in the secondary site are clones of corresponding ones of the virtualized entities in the primary site.

20. The system of claim 17, wherein the primary site data management application running on primary site infrastructure implements both of, a virtualization system that supports user virtualized entities, and a set of one or more executable containers that constitute a containerized data management application.

21. The system of claim 20, wherein the containerized data management application provides at least one of, a crash-consistent snapshot facility, or a recovery point optimization facility.

22. The system of claim 17, further comprising instructions which, when stored in memory and executed by the processor cause the processor to perform further acts of:
initiating, responsive to a loss of functionality event, automated bring-up of the data management application onto the secondary site.

23. The system of claim 22 wherein the loss of functionality event is a simulated failover event that initiates simulated orchestration and timing sequences.

24. The system of claim 17 further comprising instructions which, when stored in memory and executed by the processor cause the processor to perform further acts of:
mapping the declarative no-code configuration into computer-implementable operations;
executing at least some of the computer-implementable operations; and
carrying out remediation cycles until the desired state of the one or more data management functions has been achieved at the secondary site.
